(19) United States
(12) Patent Application Publication
(10) Pub. No.: US 2006/0265138 A1
(43) Pub. Date: Nov. 23, 2006

(54) Expression profiling of tumours

(76) Inventors: David Bowtell, East Melbourne (AU); Richard Tothill, East Melbourne (AU); Andrew Holloway, East Melbourne (AU); Adam Kowalczyk, East Melbourne (AU); Ryan Van Laar, East Melbourne (AU)

Correspondence Address: SUGHRUE MION, PLLC, 2100 PENNSYLVANIA AVENUE, N.W., SUITE 800, WASHINGTON, DC, 20037, US

(21) Appl. No.: 10/548,881

(22) PCT Filed: Mar. 12, 2004
(86) PCT No.: PCT/AU04/00299

§ 371 Date: Jul. 21, 2006

(30) Foreign Application Priority Data
Mar. 14, 2003 (AU) 2003901177
Dec. 22, 2003 (AU) 2003907084

(51) Int. Cl. G06F 19/00

(52) U.S. Cl. 702/20

(57) ABSTRACT

The present invention relates to methods of profiling tumours and characterisation of the tissue types associated with the tumours. A gene expression profile is obtained from the tissue sample, the genes ranked in order of their relative expression levels and the tissue type identified by comparing the gene ranking obtained with a database of relative gene expression level rankings of different tissue types. This gives a means to identify primary tumours and to determine the identity of a tumour of unknown primary. The invention also provides a method of treatment of a tumour by diagnosis of primary tumours identified by the methods described.

The present invention relates to methods of profiling tumours and characterisation of the tissue types associated with the tumour. The present invention also relates to a method of analysing gene expression data. Also provided is a means to identify primary tumours and to further determine the identity of a tumour of unknown primary. The invention also provides a method of treatment of a tumour by diagnosis of primary tumours identified by the methods described.

### BACKGROUND

Advances in the treatment of cancer have resulted in significant improvements in median survival times for patients with many forms of the disease. These improvements have been the result of tailoring treatments to specific types of tumours based on tissue specific molecular targets, for example hormone treatments for ovarian and breast cancers. However, if a tumour is misdiagnosed inappropriate treatment may delay recovery or have no effect on the disease. Therefore, there remains a need to correctly and reliably identify the source tissue of a tumour.

Despite the enormous amount of information regarding cancer and its diagnosis, there remains a significant proportion of new cancer cases that present with atypical symptoms. It has become apparent that the site of a tumour might belie its true origin. Metastatic tumours especially are in this class because the primary tumour may be small or undetectable, consequently a large metastasis may be misdiagnosed as the primary tumour. Carcinomas of unknown origin account for between 3 and 5% of carcinomas. For example, a so-called Krukenberg tumour is a metastatic secondary carcinoma in the ovary and represents 6% of ovarian tumours. The primary tumour is usually a mucinous carcinoma of the stomach. The definition is also broadly applied to tumours of the breast, pancreas and bowel metastatic to the ovary. Overall, approximately 20% of cancers in the ovary are thought to be of non-ovarian origin. FIG. 1 shows the most common sites of the primary in carcinoma of unknown primary in the cases where a primary is identified.

Current diagnostic techniques to identify the primary tumour in a patient with multiple disseminated metastases include morphological assessment, molecular pathological analyses including immunohistochemical staining, imaging techniques (CT, PET, mammography), and endoscopic techniques (gastroscopy, bronchoscopy, colonoscopy). While representing a small fraction of all patients, carcinoma of unknown primary accounts for the fourth most common cause of cancer death, mostly as the prognosis for these patients is bleak, with median survival eleven months. Carcinoma of unknown primary presents clinicians with a dilemma, namely how far to take investigation given the survival of patients with carcinoma of unknown primary is so poor. There is considerable debate concerning the value of detailed investigation to determine site of origin. Oncologists have been reluctant to perform low-yield investigations because of the unacceptable cost-effectiveness ratio. The cost of these investigations is not only monetary, but also impacts quality of life for the patient, and morbidity arising from invasive diagnostic procedures. Whether patients benefit from a more definitive diagnosis is unclear, however, it is the case that treatment approaches can vary significantly depending on cellular origin. For example, the drug therapies used for metastatic adenocarcinoma of the lung are significantly different to those used for metastatic adenocarcinoma of the pancreas, which, in turn are different to the therapeutic approach to metastatic colorectal adenocarcinoma.

Accordingly, it is desirable to provide a method to identify the origin of a tumour or the primary site in a carcinoma of an unknown primary so that effective treatment can be administered.

High-throughput expression analysis has recently been employed to great effect in the sub-classification of many tumour types. Since cancer is a disease of aberrant gene regulation, our ability to use microarrays to profile gene expression on a massively parallel level has begun to unravel the molecular mechanisms behind tumour initiation, progression and response to therapy. The power of large-scale genetic analysis lies in the fact that the expressions of thousands of genes are used to characterise the tumour, rather than just several markers. Many examples now exist where formerly homogenous groupings of tumours based on conventional histopathological techniques have been subdivided into groups based on molecular profiling. Not unsurprisingly, the wealth of gene expression data in several diseases has begun to support the hypothesis that morphologically indistinguishable tumours may be molecularly distinguishable. This has potentially widespread application in the clinical application of technologies aimed at refining diagnosis and prognostication in cancer.

However, with the complex data derived from expression analysis, it is difficult to discern a meaningful result to fully diagnose and identify the primary tumour.

Accordingly, it is an aspect of the invention to provide a method to identify a primary site of a tumour.

A further difficulty encountered by those trying to identify a tumour's origin occurs when a patient develops a new tumour following an earlier disease. Typically such earlier disease will have been treated and a sample of the diseased tissue may have been stored by standard techniques such paraffin embedding. In order to determine whether the new disease is related to the earlier disease it may be necessary to analyse gene expression in that archived sample. Conventional methods of gene expression analysis require high quality nucleic acid to be isolated, which is not possible from, for example, paraffin embedded tissue.

Thus, it is a further aspect of the present invention to provide a method of identifying a primary tumour from an archived or preserved sample.

### SUMMARY OF THE INVENTION

In one aspect of the present invention, there is provided a method of profiling a biological sample, said method including:
obtaining a gene expression profile from the biological sample; obtaining a gene expression database from one or more biological samples;
identifying different patterns of gene expression between the biological samples;
identifying genes that comprise the different patterns of gene expression; and
correlating the genes that comprise the different patterns of gene expression of the gene expression profile of the biological sample and the gene expression database to provide a profile of the biological sample.

In another aspect of the present invention, there is provided a method of analysing gene expression data to generate a gene expression profile or a gene expression database for use in diagnosing tumours. Preferably the method allows comparison of data obtained from different experiments.

In yet another aspect of the present invention, there is provided a gene expression database generated using a method described herein.

In a further aspect of the present invention, there is provided an expression-based diagnostic evaluation of the tissue of origin of a tumour. Preferably the expression-based evaluation is based on comparing a gene expression profile of a tumour with a gene expression database representing one or more tumour or tissue types.

In another aspect of the present invention, there is provided a method of treatment of a patient having a tumour of unknown origin including the steps of:
identifying the tissue of origin of the tumour of unknown origin; and
treating the patient in a manner appropriate for treating a tumour originating from that tissue.

An alternative gene expression profiling platform to cDNA microarray analysis is proposed using a system of high throughput RT-PCR (real time PCR). Key cancer class specific markers, identified through microarray analysis, can be easily translated to the RT-PCR method, allowing utilization of more robust and reproducible platform that could be integrated into a conventional pathology laboratory. Additionally, through using the method of RankLevels it has been shown that microarray and RT-PCR datasets can be used for building integrated SVM predictor algorithms. This allows the utilization of datasets from both platforms for training and building such predictors. The RankLevel method can also be applied to cross platform meta-analysis to use or mine pre-existing gene expression datasets.

### BRIEF DESCRIPTION OF THE FIGURES

FIG. 1 shows the most common sites of the primary in carcinoma of unknown primary.

FIG. 2 shows the results of unsupervised hierarchical clustering of gene expression data from 121 primary tumours from a diverse range of human tumours.

FIG. 3 shows a subset of genes which describes differences between tumour types.

FIG. 4 shows a graph indicating the results from the ranking of genes in order to identify a subset with the highest predictive strength.

FIG. 5 shows a confusion matrix constructed to show predictor accuracy as determined using the proportions of correct classifications from a leave-one-out cross validation in conjunction with a k-nearest neighbours algorithm.

FIG. 6 shows the validity of the predictor algorithm by using it to identify the origin of twelve samples of metastatic tumour of unknown primary.

FIG. 7 shows hierarchical clustering of ovarian (blue) and colorectal (red) primary tumours with Krukenberg-like tumours (green). All Krukenberg tumours co-cluster with colorectal primary tumour.

FIG. 8 shows that support vector machine analysis with twelve tumour types identifies a colorectal source for the five Krukenberg-like tumours shown in FIG. 7. The Y-axis represents a confidence measure of the prediction.

FIG. 9 shows a heat map alignment of data generated using cDNA microarray and RT-PCR.

FIG. 10 shows a hierarchical cluster analysis of RT-PCR data.

FIG. 11 shows the performance of RankLevels for in classification of microarray data. Experiments presents accuracy of LOO (leave-one-out) cross validation on a set of 133 cancer samples divided into 16 classes. For Figure A, full precision of pin-group normalised expressions was used, for Figures B and C used RankLevels with 3 and 5 levels, respectively.

FIG. 12 demonstrates the effect of dataset size and complexity on distribution of predictions within the three confidence levels and their relative accuracies. The Complete dataset represents LOOCV results from the complete dataset (n=229). Training/Test represents LOOCV results from Training set only (n=167). LSO represents the accumulated results from iteratively leaving sub-types from training (n=96). LCO represents accumulated results from iteratively leaving site of origin classes from training (n=229).

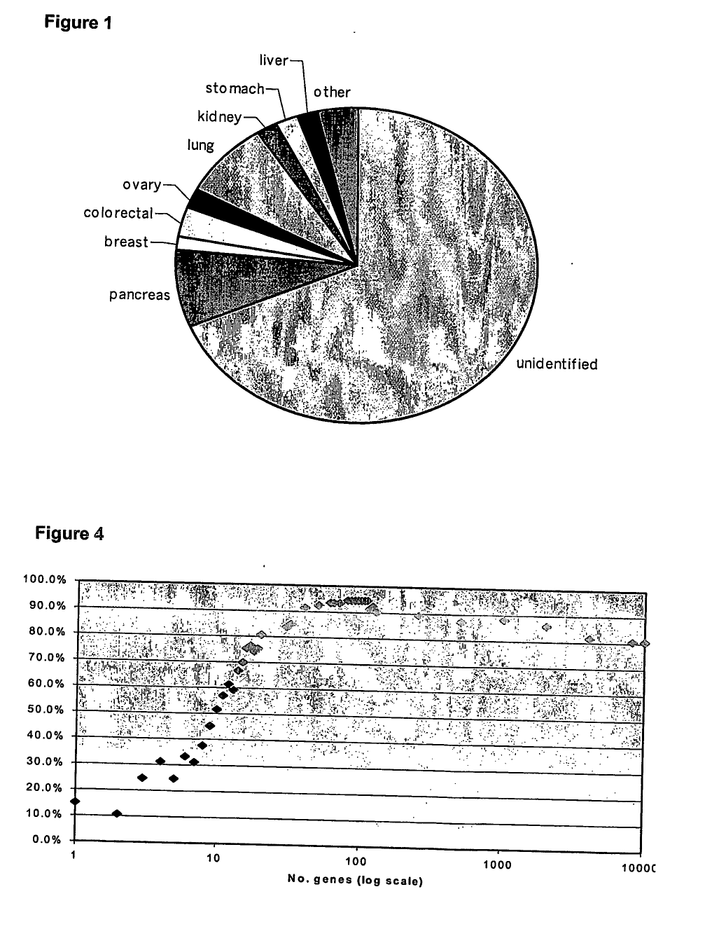

### DETAILED DESCRIPTION OF THE INVENTION

In one aspect of the present invention, there is provided a method of profiling a biological sample, said method including:

obtaining a gene expression profile from the biological sample; obtaining a gene expression database from one or more biological samples;

identifying different patterns of gene expression between the biological samples;

identifying genes that comprise the different patterns of gene expression; and

correlating the genes that comprise the different patterns of gene expression of the gene expression profile of the biological sample and the gene expression database to provide a profile of the biological sample.

Applicants have used molecular profiling techniques to characterise tumours and various tissues of biological samples based on their gene expression profile. The underlying principle of this work is that an individual cell type only expresses a subset of the total number of genes present in the genome. The fraction of genes expressed reflects and determines the biological state of the cell and provides a molecular snapshot of the cellular phenotype.

As used herein the term “gene expression profile” includes information on the expression levels of a plurality of genes within a biological sample. A biological sample within the scope of the present invention may be any biological sample that includes cellular material from which DNA, RNA or protein may be isolated. The expression level of a gene may be determined by the amount of DNA, RNA or protein present in the sample which corresponds with the gene. The gene expression profile therefore, may include levels of DNA, RNA and/or protein correlated to specific genes within the biological sample.

Gene expression levels may be obtained in a variety of ways including, but not limited to analysing DNA levels, mRNA levels, analysing protein levels and determining transcription initiation rates. Preferably gene expression levels are determined by analysis of mRNA levels. More preferably mRNA levels are determined by a hybridisation-based method or a PCR-based method.

A variety of different biological samples may be used to generate a gene expression profile. For example, the biological sample may be a tissue sample and the tissue may be normal or diseased. A diseased tissue sample may include a pre-cancerous tissue, a cancerous tissue, a tumour, a primary tumour, a metastatic tumour, or cells collected from a pleural effusion. A pre-cancerous tissue includes a tissue which may become cancerous. The biological sample may include freshly collected tissue, frozen tissue or archived tissue. In the case of archived tissue the sample may be a paraffin-embedded sample.

A gene expression profile may be established by hybridising a labelled nucleic acid sample from a biological sample to a plurality of target nucleic acids, and detecting to which of the plurality of target nucleic acids the labelled nucleic acid has bound, thereby determining which of the plurality of target nucleic acids are expressed in the biological sample and establishing a gene expression profile for the biological sample. An exemplary method of gene expression analysis by a hybridisation-based technology includes the use of a microarray. In this example, mRNA from a sample may be labelled either directly or through the synthesis of labelled cDNA. The labelled nucleic acid may then be hybridised to the microarray and expression levels determined by detecting the amount of labelled nucleic acid bound at particular positions on the microarray.

Alternatively or additionally, a PCR-based method of gene expression analysis may be used. For example, a quantitative RT-PCR technique. In this method, RNA from a biological sample may be reverse transcribed to generate segments of cDNA which may then be amplified by gene-specific quantitative PCR. The rate of accumulation of specific PCR products can be correlated to the abundance of the corresponding RNA species in the original sample and thereby provide an indication of gene expression levels. An RT-PCR method of gene expression analysis provides a robust method for obtaining expression data in a short time, compared with hybridisation-based techniques.

Both of the aforementioned techniques determine the expression of a gene by measuring the amount of mRNA corresponding to the gene.

Protein expression data may also be included in a gene expression profile since the level of a protein product generally represents the functional expression level of a gene. Protein expression levels may be determined by a hybridisation assay such as binding to an antibody or other ligand, or a functional assay where a specific protein function or activity may be measured directly.

Although less suited to high throughput or rapid analysis, transcription initiation rates may also provide an indication of gene expression levels. Such analyses require the use of a living sample in which nascent RNA transcripts are pulse labelled in vivo and analysed in a gene specific manner, generally involving hybridisation to unlabelled target nucleic acid representing the gene of interest. The labelled RNA only represents genes being actively transcribed and gives an indication of the rate of transcription initiation of a gene.

Hence a gene expression profile provides information on the expression level of a plurality of genes within a biological sample. Preferably the biological sample is a tissue sample. More preferably the biological sample is a tumour sample. The tumour sample may be of known origin or of unknown origin.

In particular embodiments of the present invention a plurality of gene expression profiles may be used to generate a gene expression database.

As used herein the term “gene expression database” refers to the expression profiles for a given sample type or types. A plurality of gene expression profiles may be used to generate the gene expression database. The gene expression profiles are statistically analysed to identify gene expression levels that characterise particular sample types. The gene expression database may also be established for a given tissue type or plurality of tissue types, and thus, in particular embodiments of the present invention, may allow the identification of the tissue from which a tumour was originally derived, by comparing the tumour's gene expression profile to the gene expression database.

Hence a gene expression database establishes a “fingerprint” of the expression profiles for a given sample type. Preferably the sample is a tissue sample. More preferably the sample is a tumour sample. In particular embodiments of the present invention a gene expression database includes gene expression information for one or more sample types, including but not limited to any one or more of the following tumours: gastric, colorectal, pancreatic, breast and ovarian.

Patterns of gene expression may be determined by statistical analysis of a gene expression profile or a gene expression database. Preferably the analysis employs an algorithm which utilises a number of informatic tools including k-nearest neighbours and a support vector machine (SVM) approach. In analyzing gene expression data, the first stage is to reduce the number of genes analysed to an optimal subset, capable of reliably describing differences between tumour types. This step is necessary as microarray-derived gene expression profiles may include data from the many thousands of genes represented on the array. Preferably, an initial step of normalizing the data is employed. Depending on the method by which the expression data is obtained, the normalization procedure may be accompanied by a Ranking System, described below. Generally, with microarray data, the number of data points is large and normalization is needed to reduce the numbers and exclude noise and aberrant data to a manageable level. However, when using RT-PCR to generate the gene expression data, the number of data points is much less and hence more manageable. Therefore, these datapoints may undergo a Ranking process at this stage as described below.

The optimal number and selection of genes for classification of tumours and biological samples from a range of primary origins is determined by using an iterative signal to noise ratio algorithm. This method ranks genes according to the difference of their mean expression values for each class of tumour, divided by the sum of the standard deviations, ie. (m₁−m₂)/(s₁+s₂). This effectively identifies those genes that have a consistently different expression measurement within a given class of tumours, relative to the values of that gene across all other tumour types present. This method may also be employed when RT-PCR is used to validate the gene expression profiles of the samples. For, instance, a microarray may be used to initially test a number of genes from which a reduced set of expressing genes indicative of the sample may then be applied to an assay such as RT-PCR which requires less gene sets (but more specific genes) and generates fewer data points.

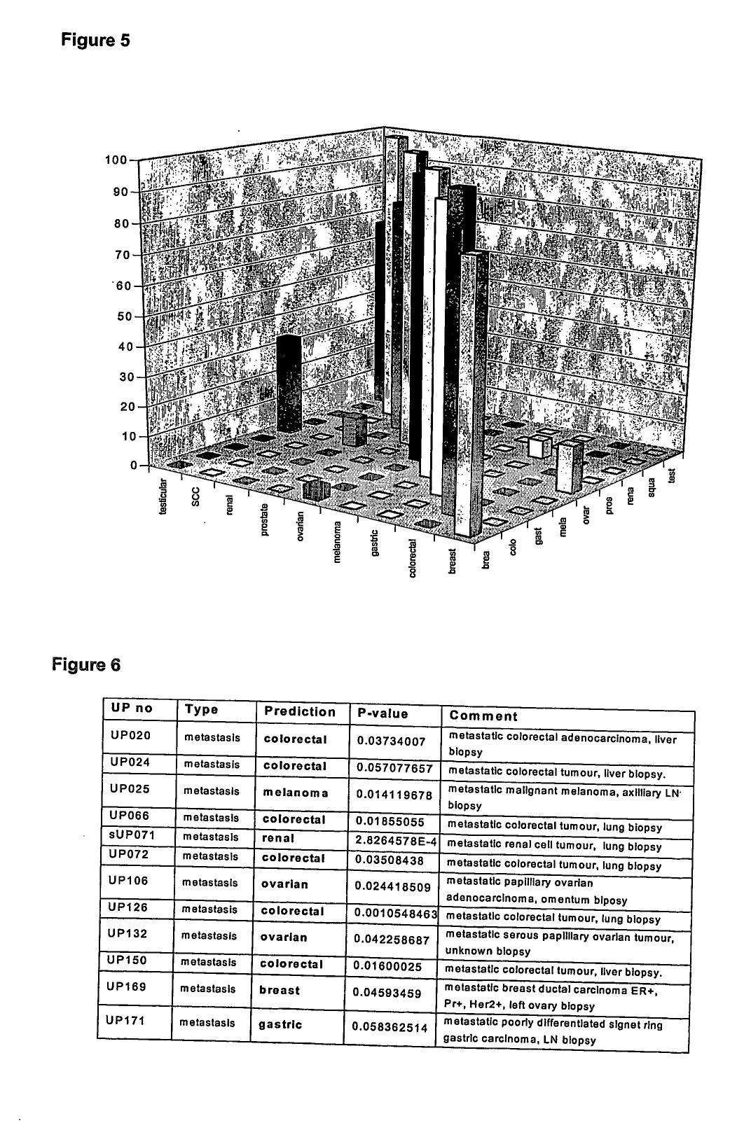

To select and test subsets of genes, a leave-one-out (LOO) cross validation in conjunction with the k-nearest neighbors algorithm can be used. Briefly, this algorithm seeks to classify an unknown sample by comparing it to samples of known class by using a distance metric. The class of the closest ‘k’ samples is assigned to the sample being tested. LOO involves permutations of the dataset whereby each sample is held out separately and a class assigned to it by using the remaining samples. This is repeated until each sample has been left out of the training set once and been assigned to a class. The proportion of correct classifications is used a measure of predictor accuracy. By plotting the actual tumour classes on one axis and the predicted classes on the other, a histogram-type view of the overall success or failure of the classification approach can be achieved. This representation (see for example FIG. 5) also allows identification of any particular classes with more incorrect predictions relative to other tumour types. The average prediction accuracy in LOO analysis in one particular training set is approximately 97%.

The applicants have generated a training set of over 120 primary tumours from a diverse range of human tumours, representing the major tumour types accounting for carcinoma of unknown primary (see Table 1). Unsupervised heirarchical clustering of gene expression data from these tumours results in a near perfect segregation of different tumour types. FIG. 2 shows the results of such a cluster, with approximately 500 genes selected on the basis of at least three samples with an expression ratio greater than or equal to 2.7.

TABLE 1
Summary of tumour samples used in training set.

| Patient ID | CancerType | DataClass | Comment |
|---|---|---|---|
| P00030 | breast | test | Primary \|ER Positive |
| P00640 | breast | test | Metastasis \|ER Positive |
| P00734 | breast | test | Primary \| |
| P00743 | breast | test | Primary \|ER Positive |
| P01026 | breast | test | Primary \|ER Negative |
| P01212 | breast | test | Primary \|ER Positive |
| P01374 | breast | test | Primary \|ER Positive |
| P01398 | breast | test | Primary \|ER Positive |
| P01696 | breast | test | Primary \|ER Positive |
| P02274 | breast | test | Primary \|ER Positive |
| P02288 | breast | test | Primary \|ER Positive |
| P00541 | colorectal | test | Primary \| |
| P00617 | colorectal | test | Primary \| |
| P01740 | colorectal | test | Primary \| |
| P01757 | colorectal | test | Primary \| |
| P01840 | colorectal | test | Primary \| |
| P02225 | colorectal | test | Primary \| |
| P02553 | colorectal | test | Primary \| |
| P02740 | colorectal | test | Primary \| |
| P00448 | Gastric | test | Primary \|Intestinal |
| P00514 | Gastric | test | Primary \|Intestinal |
| P00553 | Gastric | test | Primary \|Diffuse |
| P00559 | Gastric | test | Primary \|Intestinal |
| P00628 | Gastric | test | Primary \|Intestinal |
| P00661 | Gastric | test | Primary \|Signet ring |
| P02173 | Gastric | test | Primary \|Diffuse |
| P02176 | Gastric | test | Primary \|Diffuse |
| P02318 | Gastric | test | Primary \|Diffuse |
| P00195 | ovarian | test | Primary \|serous |
| P00446 | ovarian | test | Primary \|serous |
| P00633 | ovarian | test | Primary \|serous |
| P00756 | ovarian | test | Primary \|serous |
| P00772 | ovarian | test | Primary \|serous |
| P01164 | ovarian | test | Metastasis \|serous |
| P01246 | ovarian | test | Primary \|serous |
| P01428 | ovarian | test | Primary \|serous |
| P01436 | ovarian | test | Primary \|serous |
| P02244 | pancreas | test | Primary \| |
| P02245 | pancreas | test | Primary \| |
| P02246 | pancreas | test | Primary \| |
| P02248 | pancreas | test | Primary \| |
| P02249 | pancreas | test | Primary \| |
| P02250 | pancreas | test | Primary \| |
| P03056 | pancreas | test | Primary \| |
| P00006 | breast | trai | Primary \|ER Positive |
| P00009 | breast | trai | Primary \|ER Positive |
| P00066 | breast | trai | Primary \|ER Negative |
| P00442 | breast | trai | Primary \|ER Negative |
| P00467 | breast | trai | Primary \|ER Positive |
| P00469 | breast | trai | Primary \|ER Negative |
| P00478 | breast | trai | Primary \|ER Positive |
| P00504 | breast | trai | Primary \|ER Positive |
| P00546 | breast | trai | Primary \|ER Negative |
| P00572 | breast | trai | Primary \|ER Positive |
| P00621 | breast | trai | Primary \|ER Positive |
| P00746 | breast | trai | Primary \|ER Negative |
| P00776 | breast | trai | Primary \|ER Negative |
| P00786 | breast | trai | Primary \|ER Positive |
| P00905 | breast | trai | Primary \|ER Negative |
| P00993 | breast | trai | Primary \|ER Negative |
| P01289 | breast | trai | Metastasis \|ER Positive |
| P01292 | breast | trai | Primary \|ER Negative |
| P01579 | breast | trai | Metastasis \|ER Positive |
| P01843 | breast | trai | Primary \|ER Negative |
| P01944 | breast | trai | Metastasis \|ER Negative |
| P00002 | colorectal | trai | Primary \| |
| P00049 | colorectal | trai | Primary \| |
| P00578 | colorectal | trai | Primary \| |
| P00587 | colorectal | trai | Primary \| |
| P00721 | colorectal | trai | Metastasis \| |
| P00759 | colorectal | trai | Metastasis \| |
| P00896 | colorectal | trai | Metastasis \| |
| P00961 | colorectal | trai | Primary \| |
| P00967 | colorectal | trai | Metastasis \|Sigmoid |
| P00974 | colorectal | trai | Primary \| |
| P01016 | colorectal | trai | Metastasis \| |
| P01060 | colorectal | trai | Metastasis \| |
| P01838 | colorectal | trai | Primary \| |
| P01844 | colorectal | trai | Metastasis \| |
| P01905 | colorectal | trai | Primary \| |
| P00035 | Gastric | trai | Primary \|Diffuse |
| P00048 | Gastric | trai | Metastasis \|Signet ring |
| P00051 | Gastric | trai | Primary \|Signet ring |
| P00433 | Gastric | trai | Primary \|Diffuse |
| P00483 | Gastric | trai | Primary \|Diffuse |
| P00503 | Gastric | trai | Metastasis \|Diffuse |
| P00536 | Gastric | trai | Primary \|Diffuse |
| P00551 | Gastric | trai | Primary \|Diffuse |
| P00109 | ovarian | trai | Primary \|endometriod |
| P00130 | ovarian | trai | Primary \|serous |
| P00151 | ovarian | trai | Primary \|endometriod |
| P00155 | ovarian | trai | Primary \|serous |
| P00160 | ovarian | trai | Primary \|serous |
| P00164 | ovarian | trai | Primary \|endometriod |
| P00165 | ovarian | trai | Primary \|serous |
| P00169 | ovarian | trai | Primary \|mucinous |
| P00188 | ovarian | trai | Primary \|endometriod |
| P00488 | ovarian | trai | Primary \|mucinous |
| P00496 | ovarian | trai | Metastasis \| |
| P00505 | ovarian | trai | Primary \|endometriod |
| P00506 | ovarian | trai | Primary \|endometriod |
| P00511 | ovarian | trai | Primary \|serous |
| P00627 | ovarian | trai | Primary \|mucinous |
| P00706 | ovarian | trai | Metastasis \|serous |
| P00718 | ovarian | trai | Primary \|mucinous |
| P00784 | ovarian | trai | Primary \|mucinous |
| P00807 | ovarian | trai | Primary \|mucinous |
| P00809 | ovarian | trai | Primary \|serous |
| P00933 | ovarian | trai | Primary \|serous |
| P00935 | ovarian | trai | Primary \|mucinous |
| P01348 | ovarian | trai | Primary \|serous |
| P01563 | ovarian | trai | Primary \|serous |
| RBH 91 | ovarian | trai | Primary \|endometriod \| RBH 91.033 |
| RBH 92 | ovarian | trai | Primary \|mucinous \| RBH 92.011 |
| RBH 93 | ovarian | trai | Primary \|endometriod \| RBH 93.118 |
| RBH 93 | ovarian | trai | Primary \|endometriod \| RBH 93.061 |
| RBH 93 | ovarian | trai | Primary \|mucinous \| RBH 93.002 |
| RBH 93 | ovarian | trai | Primary \|mucinous \| RBH 93.085 |
| RBH 94 | ovarian | trai | Primary \|endometriod \| RBH 94.037 |
| RBH 94 | ovarian | trai | Primary \|endometriod \| RBH 94.120 |
| RBH 94 | ovarian | trai | Primary \|endometriod \| RBH 94.020 |
| RBH 94 | ovarian | trai | Primary \|mucinous \| RBH 94.030 |
| RBH 94 | ovarian | trai | Primary \|mucinous \| RBH 94.072 |
| RBH 94 | ovarian | trai | Primary \|mucinous \| RBH 94.080 |
| WM 090 | ovarian | trai | Primary \|malignant mucinous |
| WM 223 | ovarian | trai | Primary \|mucinous |
| WM 438 | ovarian | trai | Primary \|mucinous |
| WM 439 | ovarian | trai | Primary \|mucinous |
| WM 454 | ovarian | trai | Primary \|malignant mucinous |
| P02078 | pancreas | trai | Primary \| |
| P02247 | pancreas | trai | Primary \| |
| P00815 | Lung | trai2 | Primary \|scc |
| P00817 | Lung | trai2 | Primary \|scc |
| P00925 | Lung | trai2 | Primary \|scc |
| P01323 | Lung | trai2 | Primary \|scc |
| P01400 | Lung | trai2 | Primary \|scc |
| P01759 | Lung | trai2 | Primary \|adenocarcinoma |
| P01770 | Lung | trai2 | Primary \|adenocarcinoma |
| P01907 | Lung | trai2 | Primary \|scc |
| P01909 | Lung | trai2 | Primary \|adenocarcinoma |
| P02021 | Lung | trai2 | Primary \|scc |
| P02023 | Lung | trai2 | Primary \|adenocarcinoma |
| P02024 | Lung | trai2 | Primary \|large cell |
| P02025 | Lung | trai2 | Primary \|adenocarcinoma |
| P02026 | Lung | trai2 | Primary \|adenocarcinoma |
| P02028 | Lung | trai2 | Primary \|large cell |
| P02029 | Lung | trai2 | Primary \|scc |
| P02030 | Lung | trai2 | Primary \|large cell |
| P02031 | Lung | trai2 | Primary \|scc |
| P02032 | Lung | trai2 | Primary \|adenocarcinoma |
| P02033 | Lung | trai2 | Primary \|adenocarcinoma |
| P02034 | Lung | trai2 | Primary \|large cell |
| P02035 | Lung | trai2 | Primary \|adenocarcinoma |
| P02037 | Lung | trai2 | Primary \|adenocarcinoma |
| P02038 | Lung | trai2 | Primary \|adenocarcinoma |
| P02039 | Lung | trai2 | Primary \|scc |
| P02040 | Lung | trai2 | Primary \|large cell |
| P02041 | Lung | trai2 | Primary \|large cell |
| P02042 | Lung | trai2 | Primary \|large cell |
| P02043 | Lung | trai2 | Primary \|scc |
| P02044 | Lung | trai2 | Primary \|scc |
| P02045 | Lung | trai2 | Primary \|large cell |
| P02090 | Lung | trai2 | Primary \|large cell |
| P00508 | melanoma | trai2 | Metastasis \| |
| P00576 | melanoma | trai2 | Metastasis \| |
| P00761 | melanoma | trai2 | Metastasis \| |
| P00825 | melanoma | trai2 | Metastasis \| |
| P00833 | melanoma | trai2 | Metastasis \| |
| P00923 | melanoma | trai2 | Metastasis \| |
| P00977 | melanoma | trai2 | Metastasis \| |
| P00979 | melanoma | trai2 | Metastasis \| |
| P01537 | melanoma | trai2 | Metastasis \| |
| P01861 | melanoma | trai2 | Metastasis \| |
| P01726 | mesothelioma | trai2 | Primary \| |
| P01728 | mesothelioma | trai2 | Primary \| |
| P01729 | mesothelioma | trai2 | Primary \| |
| P01730 | mesothelioma | trai2 | Primary \| |
| P01731 | mesothelioma | trai2 | Primary \| |
| P01733 | mesothelioma | trai2 | Primary \| |
| P00050 | Oesophageal | trai2 | Primary \|Mixed |
| P00450 | Oesophageal | trai2 | Primary \|Diffuse |
| P00032 | prostate | trai2 | Primary \| |
| P00880 | prostate | trai2 | Primary \| |
| P00890 | prostate | trai2 | Primary \| |
| P00954 | prostate | trai2 | Primary \| |
| P01109 | prostate | trai2 | Primary \| |
| P01421 | prostate | trai2 | Primary \| |
| P01653 | prostate | trai2 | Primary \| |
| P01813 | prostate | trai2 | Primary \| |
| P00916 | renal | trai2 | Metastasis \| |
| P00998 | renal | trai2 | Primary \| |
| P01020 | renal | trai2 | Primary \| |
| P01038 | renal | trai2 | Primary \| |
| P01043 | renal | trai2 | Primary \| |
| P01048 | renal | trai2 | Primary \|Clear cell |
| P01098 | renal | trai2 | Primary \| |
| P01218 | renal | trai2 | Primary \| |
| P01270 | renal | trai2 | Primary \|Clear cell |
| P01278 | renal | trai2 | Primary \| |
| P01574 | renal | trai2 | Metastasis \| |
| P01817 | renal | trai2 | Primary \| |
| P01908 | renal | trai2 | Metastasis \| |
| P01093 | SCCother | trai2 | Primary \|Larynx, NOS |
| P01158 | SCCother | trai2 | Primary \|Tongue, NOS |
| P01308 | SCCother | trai2 | Primary \|Tongue, NOS |
| P01343 | SCCother | trai2 | Primary \|Pharynx, NOS |
| P01394 | SCCother | trai2 | Primary \|Pyriform sinus |
| P01472 | SCCother | trai2 | Primary \|Larynx, NOS |
| P01749 | SCCother | trai2 | Primary \|Larynx, NOS |
| P01273 | SCCother Skin | trai2 | Primary \|skin of lip, NOS |
| P01341 | SCCother Skin | trai2 | Unknown \|Unknown primary site |
| P01371 | SCCother Skin | trai2 | Primary \|Skin, NOS |
| P01402 | SCCother Skin | trai2 | Primary \|Skin of scalp and neck |
| P01633 | SCCother Skin | trai2 | Primary \|Skin of other and unspecified parts of face |
| P01660 | SCCother Skin | trai2 | Primary \|Skin, NOS |
| P01766 | SCCother Skin | trai2 | Primary \|Skin of other and unspecified parts of face |
| P01832 | SCCother Skin | trai2 | Unknown \|Unknown primary site |
| P00876 | testicular | trai2 | Primary \| |
| P01124 | testicular | trai2 | Primary \| |
| P02345 | testicular | trai2 | Primary \| |
| P00635 | uterine | trai2 | Primary \|endometriod |
| P00724 | uterine | trai2 | Primary \|endometriod |
| P00741 | uterine | trai2 | Primary \|endometriod |
| P00742 | uterine | trai2 | Primary \|endometriod |
| P00848 | uterine | trai2 | Primary \|endometriod |
| P00909 | uterine | trai2 | Primary \|endometriod |
| P00940 | uterine | trai2 | Primary \|endometriod |
| P00943 | uterine | trai2 | Primary \|endometriod |
| P01872 | uterine | trai2 | Primary \|endometriod |

Key:
test: samples processed on MFC,
trai: samples processed by microarray not by MFC
trai2: samples not used for MFC

In a preferred embodiment of the present invention there is provided a set of approximately 90 genes (see Table 2 below), many of which may be used for discriminating between a plurality of sample types, including but not limited to any one or more of the following tumours: gastric, colorectal, pancreatic, breast and ovarian.

TABLE 2
A set of genes useful in discriminating gastric, colorectal, pancreatic, breast and ovarian tumours.

| Genbank | RefSeq | Name | Symbol | Class |
|---|---|---|---|---|
| AA291749 | NM_000125 | estrogen receptor 1 | ESR1 | brea |
| AA479494 | NM_020423 | ezrin-binding partner PACE-1 | PACE-1 | brea |
| AA479888 | NM_004703 | rabaptin-5 | RAB5EP | brea |
| AA482035 | NM_014804 | KIAA0753 gene product | KIAA0753 | brea |
| AA489647 | NM_004354 | cyclin G2 | CCNG2 | brea |
| AI362703 | NM_007255 | xylosylprotein beta 1,4-galactosyltransferase, polypeptide 7 (galactosyltransferase I) | B4GALT7 | brea |
| AI635773 | NM_025202 | likely ortholog of neuronally expressed calcium binding protein | FLJ13612 | brea |
| AI669721 | NM_014112 | trichorhinophalangeal syndrome I | TRPS1 | brea |
| AI972286 | NM_002652 | prolactin-induced protein | PIP | brea |
| H10045 | NM_006113 | vav 3 oncogene | VAV3 | brea |
| H29315 | NM_012319 | LIV-1 protein, estrogen regulated | LIV-1 | brea |
| H72875 | NM_002051 | GATA binding protein 3 | GATA3 | brea |
| N23299 | NM_014674 | ER degradation enhancing alpha mannosidase-like | EDEM | brea |
| N49284 | NM_005375 | v-myb myeloblastosis viral oncogene homolog (avian) | MYB | brea |
| R06567 | NM_003629 | phosphoinositide-3-kinase, regulatory subunit, polypeptide 3 (p55, gamma) | PIK3R3 | brea |
| R63647 | NM_000949 | prolactin receptor | PRLR | brea |
| H95792 | NM_001609 | acyl-Coenzyme A dehydrogenase, short/branched chain | ACADSB | brea |
| AA088420 | NM_015869 | peroxisome proliferative activated receptor, gamma | PPARG | colo |
| AA099136 | NM_002296 | lamin B receptor | LBR | colo |
| AA130579 | NM_006149 | lectin, galactoside-binding, soluble, 4 (galectin 4) | LGALS4 | colo |
| AA130584 | NM_004363 | carcinoembryonic antigen-related cell adhesion molecule 5 | CEACAM5 | colo |
| AA262074 | NM_147130 | natural cytotoxicity triggering receptor 3 | NCR3 | colo |
| AA279081 | NM_015250 | coiled-coil protein BICD2 | BICD2 | colo |
| AA284184 | NM_018438 | F-box only protein 6 | FBXO6 | colo |
| AA406571 | NM_001712 | carcinoembryonic antigen-related cell adhesion molecule 1 (biliary glycoprotein) | CEACAM1 | colo |
| AA465495 | NM_016234 | fatty-acid-Coenzyme A ligase, long-chain 5 | FACL5 | colo |
| AA699679 | NM_003889 | nuclear receptor subfamily 1, group I, member 2 | NR1I2 | colo |
| AA975612 | NM_012396 | pleckstrin homology-like domain, family A, member 3 | PHLDA3 | colo |
| AI433336 | NM_007127 | villin 1 | VIL1 | colo |
| AI681730 | NM_007052 | NADPH oxidase 1 | NOX1 | colo |
| AW009320 | NM_001804 | caudal type homeo box transcription factor 1 | CDX1 | colo |
| N74131 | NM_003226 | trefoil factor 3 (intestinal) | TFF3 | colo |
| W72792 | NM_004442 | EphB2 | EPHB2 | colo |
| AA490044 | NM_006933 | solute carrier family 5 (inositol transporters), member 3 | SLC5A3 | gast |
| AA664101 | NM_000689 | aldehyde dehydrogenase 1 family, member A1 | ALDH1A1 | gast |
| AA702350 | NM_015570 | autism susceptibility candidate 2 | AUTS2 | gast |
| AA702640 | NM_000790 | dopa decarboxylase (aromatic L-amino acid decarboxylase) | DDC | gast |
| AA845156 | NM_003122 | serine protease inhibitor, Kazal type 1 | SPINK1 | gast |
| AI090702 | NM_014970 | kinesin-associated protein 3 | KIFAP3 | gast |
| AI333599 | NM_019617 | 18 kDa antrum mucosa protein | AMP18 | gast |
| AW009769 | NM_003225 | trefoil factor 1 (breast cancer, estrogen-inducible sequence expressed in) | TFF1 | gast |
| AW029441 | NM_002630 | progastricsin (pepsinogen C) | PGC | gast |
| AW058221 | NM_004190 | lipase, gastric | LIPF | gast |
| H23187 | NM_000067 | carbonic anhydrase II | CA2 | gast |
| H94487 | NM_001910 | cathepsin E | CTSE | gast |
| N63943 | NM_000239 | lysozyme (renal amyloidosis) | LYZ | gast |
| R32848 | NM_005980 | S100 calcium binding protein P | S100P | gast |
| R39069 | NM_003558 | phosphatidylinositol-4-phosphate 5-kinase, type I, beta | PIP5K1B | gast |
| T60861 | NM_017846 | tRNA selenocysteine associated protein | SECP43 | gast |
| AA405767 | NM_013952 | paired box gene 8 | PAX8 | ovar |
| AA419229 | NM_144586 | hypothetical protein MGC29643 | MGC29643 | ovar |
| AA453742 | NM_004172 | solute carrier family 1 (glial high affinity glutamate transporter), member 3 | SLC1A3 | ovar |
| AA459363 | NM_017495 | RNA-binding region (RNP1, RRM) containing 1 | RNPC1 | ovar |
| AA621342 | NM_015415 | DKFZP564B167 protein | DKFZP564B167 | ovar |
| AA683520 | NM_003064 | secretory leukocyte protease inhibitor (antileukoproteinase) | SLPI | ovar |
| AI139437 | NM_005046 | kallikrein 7 (chymotryptic, stratum corneum) | KLK7 | ovar |
| AI963941 | NM_144505 | kallikrein 8 (neuropsin/ovasin) | KLK8 | ovar |
| N52450 | NM_033624 | F-box only protein 21 | FBXO21 | ovar |
| R24530 | NM_016730 | folate receptor 1 (adult) | FOLR1 | ovar |
| AA122287 | NM_005512 | glycoprotein A repetitions predominant | GARP | panc |
| AA450265 | NM_002592 | proliferating cell nuclear antigen | PCNA | panc |
| AA454651 | NM_020831 | megakaryoblastic leukemia (translocation) 1 | MKL1 | panc |
| AA670378 | NM_014504 | putative Rab5 GDP/GTP exchange factor homologue | RABEX5 | panc |
| AA670429 | NM_003020 | secretory granule, neuroendocrine protein 1 (7B2 protein) | SGNE1 | panc |
| AA844864 | NM_006507 | regenerating islet-derived 1 beta (pancreatic stone protein, pancreatic thread | REG1B | panc |
| | | protein) | | |
| AA845178 | NM_001868 | carboxypeptidase A1 (pancreatic) | CPA1 | panc |
| AA894687 | NM_004515 | interleukin enhancer binding factor 2, 45 kDa | ILF2 | panc |
| AI651194 | NM_015089 | p53-associated parkin-like cytoplasmic protein | PARC | panc |
| AI669320 | NM_006418 | differentially expressed in hematopoietic lineages | GW112 | panc |
| AI685081 | NM_000207 | insulin | INS | panc |
| AI829222 | NM_000371 | transthyretin (prealbumin, amyloidosis type I) | TTR | panc |
| T54662 | NM_001832 | colipase, pancreatic | CLPS | panc |
| W45219 | NM_006229 | pancreatic lipase-related protein 1 | PNLIPRP1 | panc |
| W72322 | NM_001419 | ELAV (embryonic lethal, abnormal vision, Drosophila)-like 1 (Hu antigen R) | ELAVL1 | panc |
| AA400464 | NM_000346 | SRY (sex determining region Y)-box 9 (campomelic dysplasia, autosomal sex-reversal) | SOX9 | oth |
| AA402040 | NM_014428 | tight junction protein 3 (zona occludens 3) | TJP3 | oth |
| AA430665 | NM_001305 | claudin 4 | CLDN4 | oth |
| AA443558 | NM_032420 | protocadherin 1 (cadherin-like 1) | PCDH1 | oth |
| AA477165 | NM_002906 | radixin | RDX | oth |
| AA676466 | NM_054012 | argininosuccinate synthetase | ASS | oth |
| AA872020 | NM_002773 | protease, serine, 8 (prostasin) | PRSS8 | oth |
| AA972350 | NM_000542 | surfactant, pulmonary-associated protein B | SFTPB | oth |
| AI002217 | NM_003019 | surfactant, pulmonary-associated protein D | SFTPD | oth |
| N58558 | NM_006215 | serine (or cysteine) proteinase inhibitor, clade A (alpha-1 antiproteinase, | SERPINA4 | oth |
| | | antitrypsin), member 4 | | |
| N68998 | NM_014382 | ATPase, Ca++ transporting, type 2C, member 1 | ATP2C1 | oth |
| R99562 | NM_004497 | forkhead box A3 | FOXA3 | oth |
| AA001444 | NM_002398 | Meis1, myeloid ecotropic viral integration site 1 homolog (mouse) | MEIS1 | ovar |
| AA130187 | NM_024426 | Wilms tumour 1 | WT1 | ovar |
| AA142980 | NM_015470 | gamma-SNAP-associated factor 1 | GAF1 | ovar |
| H89996 | NM_006565 | CCCTC-binding factor (zinc finger protein) | CTCF | control |
| AA430524 | NM_004930 | capping protein (actin filament) muscle Z-line, beta | CAPZB | control |
| AA078976 | NM_004786 | thioredoxin-like, 32 kDa | TXNL | control |
| AA421230 | NM_012433 | splicing factor 3b, subunit 1, 155 kDa | SF3B1 | control |
| AA456028 | NM_004582 | Rab geranylgeranyltransferase, beta subunit | RABGGTB | control |
| AA419281 | NM_002046 | glyceraldehyde-3-phosphatede hydrogenase | GAPD | control |

An alternative or complementary method for analysis of a gene expression database uses analyses similar to those described above to identify a subset of informative genes which may be used to discriminate between various sample types. For example a subset of approximately 90 genes may be used to discriminate between five classes of tumours: gastric, colorectal, pancreatic, breast and ovarian. Expression levels of each of those genes may then be ranked within each sample type thus resulting in an ordered list of genes that may be used to discriminate between different samples based on the relative expression levels of specific genes. This is known as Ranking, as herein described. This method has particular application and utility as it provides a method by which a sample may be identified without reference to a database. In a preferred embodiment a sample may be analyzed for expression levels of a specific set of genes, the relative expression levels of those genes may then be determined and ranked, then compared to a listing generated from different samples on the same set of genes, thereby providing a simple method of identifying the sample. This ranking procedure allows for meta-analysis which provides for cross-platform comparisons of gene expression profiles and databases.

In another aspect of the present invention, there is provided a method of analysing gene expression data to generate a gene expression profile or a gene expression database for use in diagnosing tumours. Preferably the method uses normalising gene expression data which allows comparison of data obtained from different experiments.

The methods described above relating to the generation and analysis of a gene expression profile or a gene expression database will now be described in more detail in this specific example. However, this application is not limited to this description and should not limit the generality of this invention.

As the present invention may use data generated from a variety of gene expression analysis methods including, but not limited to, microarray analysis and RT-PCR, a statistical method is required which facilitates amalgamation of these data into a form which allows comparison of these different data. Applicants have also developed a Ranking System which is a surprisingly straightforward and robust approach to gene expression analysis.

Current microarray based measurements of gene expression are very noisy. This applies in particular to spotted array technologies used for development of this invention. The current dogma is that the raw measurement values have to be accordingly normalised, then various machine learning techniques should/could be applied to the normalised expression levels. A particular aim of the normalisation is to combat the noise and some innate biases of the technology, such as the non-linear dependence between intensity and level of hybridisation of the Cy3 and Cy5 channels, wherein, Cy3 and Cy5 are fluorescent dyes used to label probes for the detection of nucleic acid hybridisation to microarrays. A number of sophisticated statistical normalisation techniques were custom designed to suit various microarray platforms and results of their experimental evaluations can be found in the literature. These include the intensity dependent loess pin group normalisation for spotted arrays of Yang et al (2002, Nucleic Acids Res 30(4): e15), the SNOMAD algorithm of Colantuoni et al (2002, Biotechniques 32(6): 1316-20) for spatial normalisation of spotted arrays, standardisation of gene expression values for Affymetrix array data to zero mean and unit standard deviation and universally applied log transformation alleviating routinely observed large dynamic ranges of expression values.

The present invention introduces, in particular, a novel normalisation technique based on ranking. Applicants propose to rank all genes according to their expression levels, then allocate to each gene a rough level of its rank (RankLevel). The RankLevels are then used for statistical analysis and predictive modelling instead of using normalised expression levels.

Effectively, raw expression data is obtained which provides a gene expression profile. This raw expression data may be obtained by microarray or RT-PCR analysis or any means that provides gene expression data. This data is preferably normalized and reduced to a manageable level before processing through a k-nearest neighbours or SVM procedure or any learning algorithm process which is trained from the the data in a gene expression database. The ranking system, described herein, ranks the expression levels of the various data points within a sample.

Each data point represents an expression of a gene and is measured by the relative abundance of mRNA species in the sample compared to expression of that gene in a reference sample or median expression across many samples or genes. The intensity is assigned an intensity level which is determined relative to a reference point such as the background. Hence an intensity ratio or expression ratio may be obtained which represents the data point. This intensity or expression ratio is then ranked along with other data points within the sample ranging from the lowest intensity to the highest intensity. Each data point is then allocated a rank number. It is this rank number which is used to determine the rank level.

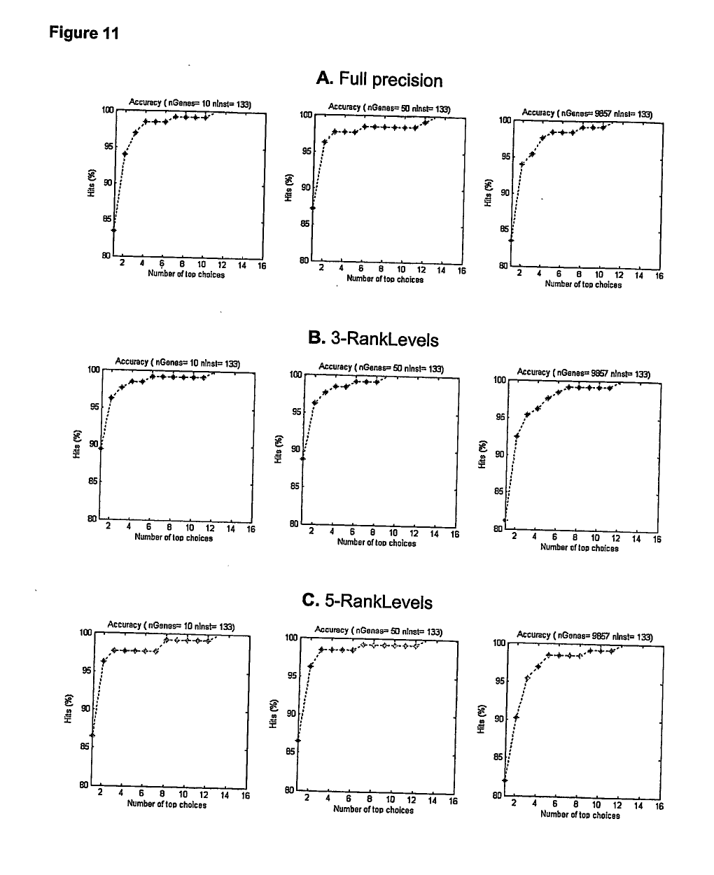

More specifically, if the expression ratio of a gene A is say 1.883 and gene B is 10.34, these values may be ranked as 5405 and 7283 among all 8378 genes of the array ordered from the lowest to the highest gene expression. Therefore, they are the 5405^{th} and the 7283^{rd} intense genes of the 8378 genes analysed A random number of rank levels may be assigned. Preferably, these are ranked from 1 to 10. However, any number may be assigned. Useful ranks are between 2 to 10, most preferably 4 to 10, more preferably, 5 to 10. Assuming 5 RankLevels are used, then these genes are allocated RankLevels according to the following formula:
RankLevel(A)=ceil(5*5405/8378)=ceil(3.22)=4,
RankLevel(B)=ceil(5*7283/8378)=ceil(4.34)=5,
where ceil(x) denotes smallest integer≧x. Thus, for building a predictive model based on RankLevels the values 4 and 5 can be used instead of the original values 1.883 and 10.34 for the expression of gene A and B, respectively. Surprisingly, in spite of its crudeness, the RankLevel value allows development of very accurate predictive models (FIG. 11). The intuitive explanation is that for successful predictive modelling the consistency of the features used to represent measurement is paramount. Thus although RankLevels may lose accuracy of expression level, they gain in stability, since crude RankLevels are more likely to be unchanged or not changed significantly between various experiments. The RankLevels naturally eliminate the issue of huge dynamic range of expression values and global variations between average expression levels of different microarray slides. Hence a general formula for determining a RankLevel is as follows:

$$\begin{matrix}RankLevel = ceil ( number of rank levels \times rank \text{/} number of genes \\ assayed ) \\ = ceil ( x ) \\ wherein ceil ( x ) = smallest integer \geq x\end{matrix}$$

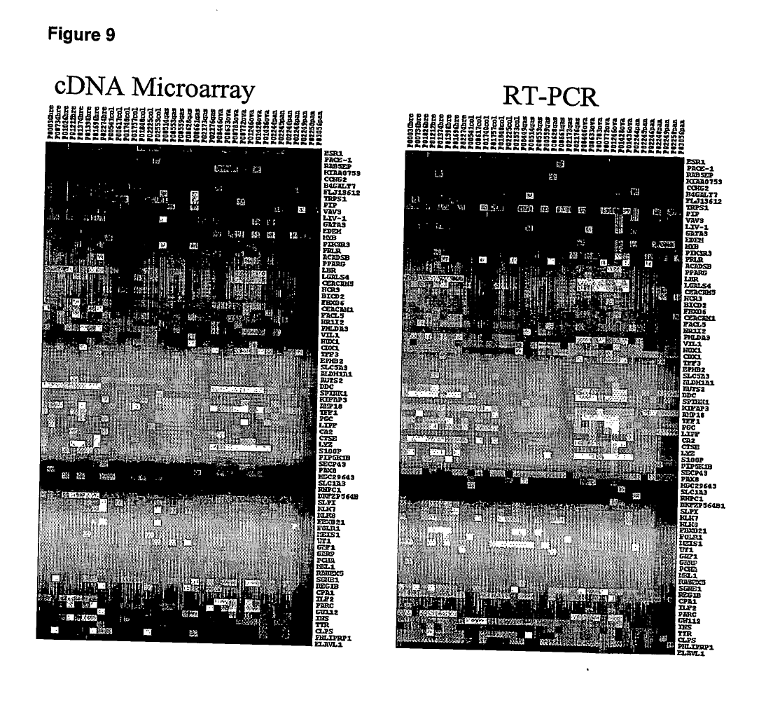

Another important property of RankLevels is that models built on them can be easily transferred across various technologies for measuring gene expression levels, as long as the monotonicity of measurement across the technological platforms is roughly preserved. In various experiments applicants have very successfully transferred predictive models developed for spotted microarrays to RT-PCR and vice versa (Example 7 and FIG. 9). The same transfer can be done between other platforms, for instance, the spotted arrays and Affymetrix arrays. Note also that RankLevels are readily applicable to a mixture of arrays with different total number of genes that paves an avenue to practical statistical analysis and modelling across large amounts of data from a variety of studies developed by different laboratories using various technologies.

RankLevel based models (using small number of rank levels, say 2-5) are also very amenable to human comprehension and rationalisation that can be readily carried across range of technological platforms. In this context RankLevel normalization is especially attractive proposition, for emerging applications of microarray and RT-PCR technology and for other high throughput genetic experiments and their applications.

High-throughput expression analysis can be employed to great effect in the sub-classification of many tumour types. The wealth of gene expression data in several diseases has begun to support the hypothesis that morphologically indistinguishable tumours may be molecularly distinguishable. This has potentially widespread application in the clinical application of technologies aimed at refining diagnosis and prognostication in cancer.

In yet another aspect of the present invention, there is provided a gene expression database generated using a method described herein. Preferably, the gene expression database includes a subset of genes selected to demonstrate differences in expression between sample types, and arranged according to their RankLevel as described above.

In a preferred embodiment the present invention provides a gene expression database which includes gene expression data from a variety of tumour types. Preferably the tumour types includes at least one of the following: gastric, colorectal, pancreatic, breast and ovarian.

In a further aspect of the present invention, there is provided an expression-based diagnostic evaluation of the tissue of origin of a tumour. Preferably the expression-based evaluation is based on comparing a gene expression profile of a tumour with a gene expression database representing one or more tumour or tissue types. More preferably, the comparison is based on comparing RankLevels between the gene expression profile and the gene expression database.

Being able to provide disease appropriate treatment is essential in order to provide the best level of care for a patient. Given that different tumour types respond differently to different treatment regimens, it is therefore beneficial to be able to correctly diagnose a patient's tumour. At present in medicine, the ability to classify tumours is based upon the use of a limited number of markers, which are often thought to be “tumour specific” in expression but in practice may produce equivocal results regarding the tissue of origin of a tumour sample. For instance, although the estrogen receptor is employed as a diagnostic marker for breast cancer, the molecule is expressed in only a small percentage of clinically identifiable breast cancer samples. To further complicate the analysis, the estrogen receptor is also expressed in various other tumour types. Thus present diagnosis is based on a limited set of imperfect predictors.

As stated above, the fraction of genes expressed in a cell reflects and determines the biological state of that cell and provides a molecular snapshot of the cellular phenotype. Despite being propagated for many years in vitro, cell lines retain some level of lineage specific expression. This has the effect of allowing cell lines of similar origin to co-cluster following gene expression analyses. In addition, expression profiles of tumour cells in vivo or in vitro may group the cells according to their presumptive tissue of origin. Our ability to rapidly profile the expression of many thousands of genes simultaneously, and use that information to diagnose the origin of a tumour has as yet not been reflected in modem diagnostics. The power of molecular profiling as an approach to diagnostic evaluation of tumours lies in the fact that instead of deriving information about a tumour from a handful of markers, the expression of thousands of genes contributes to an overall picture of the tumour cells. The present invention confirms the diagnostic utility of such an approach, and foreshadows an expanding use of this technology. Preferably the expression-based evaluation uses expression data generated by the use of microarray technology to determine RNA expression levels in a sample. Alternatively or additionally, the expression-based evaluation uses expression data generated by the use of quantitative RT-PCR technology to determine RNA expression levels in a sample.

The use of microarrays and quantitative RT-PCR generates a large amount of data and requires considerable analysis to identify an optimal subset of genes, as discussed above. Once an optimal subset of genes has been identified, it is only necessary to investigate those genes in the optimal subset in order to perform identification according to the present invention.

In a particular embodiment of the present invention there is provided a method by which a tissue of origin or a tumour of origin may be assigned to a biological sample, the method including the steps of:
obtaining a gene expression profile of the biological sample; and
comparing the gene expression profile to a gene expression database; wherein the gene expression database includes gene expression data relating to various tissue types or tumour types;
   wherein similarities and differences between the gene expression profile and the gene expression database allow assignment of the tissue of origin or the tumour of origin to the biological sample.

In a preferred embodiment the biological sample is a tumour sample. More preferably the tumour sample is an unidentified adenocarcinoma. Preferably the gene expression database includes gene expression data relating to any one or more of the following tumour types: gastric, colorectal, pancreatic, breast and ovarian.

Thus the present invention provides a method of diagnosing a patient's tumour by comparing a gene expression profile of the patient's tumour with a gene expression database generated from known tumour types.

In a particular embodiment of the present invention the methods of the invention can be used to identify a tumour of unknown origin.

In a specific, but non-limiting example, the present application illustrates the process in the identification of tumours found in the ovary, but suspected to be extra-ovarian in origin. Approximately 10-20% of patients presenting with ovarian malignancies have tumours suspected to be of extra-ovarian origin, rather than primary ovarian cancers. Tumours that metastasise from the stomach to the ovary and present as primary ovarian cancer are typically referred to as Krukenberg tumours but the term has also been more broadly applied to colon, breast and pancreatic secondaries to the ovary. Combining the data from a number of studies, in a total of 68 Krukenberg tumours, approximately 40% are metastatic from the stomach, 25% are colorectal in origin, 10% arise in the breast, and 25% arise elsewhere or do not have a primary site diagnosed. Prior to surgery many of these patients have clinical and CT findings consistent with a diagnosis of ovarian cancer, and hence undergo a laparotomy. In many of these patients no evidence of another primary is found at operation, and subsequent investigations often do not reveal a primary. The pathologist may suspect that such a tumour is of non-ovarian origin based on the morphologic appearance and immunohistochemical profile, but is generally not able to exclude the possibility that it could be a primary ovarian cancer, nor suggest a more likely origin. Generally these patients are given the benefit of the doubt and are treated with platinum based chemotherapy as per standard management of ovarian cancer. They usually respond poorly, and in some instances an extra-ovarian primary becomes apparent at a later date.

The present invention also provides a method of using a gene expression database according to the present invention for prognosis and/or diagnosis of a patient.

Conventional methods for treatment of cancer rely upon clinical parameters relating to anatomical site of origin, grade and spread of disease. These observations today are essentially made through such modalities as intra-operative assessment, conventional pathology through light microscopy and a suite of imaging techniques. For a proportion of tumours several molecular markers can also be used to predict the behaviour of the disease or to assess the suitability of a patient for specific treatment. One example is breast tumours that express the cell surface estrogen receptor (ESR). Such patients are known to respond to treatment with the ESR antagonist tamoxifen and it is commonly used as an adjuvant therapy for low grade breast cancers. For a large proportion of tumours, however, there are currently no methods for assessing such prognostic factors. Two cancer cases that may appear identical in their pathological and clinical profiles, may respond differently to chemotherapy or radiotherapy, they may also show a different prevalence to recur and may or may not metastasise. Underlying this phenotypic behaviour are the molecular mechanisms relating to tumour development, its cellular functioning and the relationship it has with the rest of the body.

Using gene expression microarray analysis the activity of thousands of genes can be used to identify expression patterns related to the phenotypic behaviour. A gene expression dataset of samples that have been clinically annotated to study specific prognostic factors, relating to treatment suitability or recurrence, can be used to identify the associated molecular markers or molecular pathways. Therefore, similar to the application for identifying site of origin, where tissue differentiation markers may elude to the identity of a primary tumour, markers relating to cell survival, angiogenesis, metastasis or T-cell infiltration may be associated with tumour behaviour, patient survival or other prognostic factors.

Identification of such markers or expression profiles can be translated to clinically viable tests using similar methods discussed here allowing better cancer patient management.

In another aspect of the present invention, there is provided a method of treatment of a patient having a tumour of unknown origin including the steps of:
identifying the tissue of origin of the tumour of unknown origin; and
treating the patient in a manner appropriate for treating a tumour originating from that tissue site.

Identification of the tissue of origin permits disease-appropriate therapy to be given to a patient and thereby give the patient the best chance of receiving an effective treatment. Such treatments are known to those skilled in the art and vary between different tumour origins.

Preferably, the step of identifying a tissue of origin of the tumour of unknown origin is as described herein. However, this aspect of the invention is based on the underlying principle that an individual cell type only expresses a subset of the total number of genes present in the genome. The fraction of genes expressed reflects and determines the biological state of the cell and provides a molecular snapshot of the cellular phenotype. This is carried through to the secondary or metastatic tumours and provides and identification system of their origin which allows for appropriate treatment which may not coincide with the surrounding tissue type and treatment of tumours of that tissue type.

Throughout the description and claims of this specification, the word “comprise” and variations of the word, such as “comprising” and “comprises”, is not intended to exclude other additives, components, integers or steps.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed in Australia before the priority date of each claim of this application.

Examples of the procedures used in the present invention will now be more fully described. It should be understood, however, that the following description is illustrative only and should not be taken in any way as a restriction on the generality of the invention described above.

### EXAMPLES

### Example 1

### Creating a Gene Expression Database

A training dataset containing the gene expression measures of approximately 10,000 genes in a wide range of human tumour types was created. To develop the dataset, and also to ensure its usefulness for diagnosing tumour type from small biopsies, a protocol incorporating an amplification step in preparation of labelled cDNA for hybridisation was used. The protocol reliably produced expression data from 3 μg of starting total RNA. Amplification was an important approach to take, as the amount of tissue available is often limited to small amounts in excess of tissue required for other diagnostic purposes. In particular, the approach allows utilising small biopsies (for example core biopsy or fine needle aspirate) of tissue collected from metastatic deposits that would otherwise not be collectable by excision biopsy.

a) Collection of Tissue Samples

All human tumour material was collected and used in accordance with the Ethical Principles as described in the Australian National Health and Medical Research Council National Statement on Ethical Conduct in Research Involving Humans. Histopathology of the tumour samples was reviewed to ensure an unequivocal clinical diagnosis. Metastatic tumours arising from known primary tumour were obtained from patients with clear clinical history of metastatic disease. Pathology review of these samples unequivocally identified the primary site. Metastatic tumour arising from an unknown primary tumour was submitted after substantial clinical workup. Immunohistochemical and morphological staining and review were carried out according to standard protocols.

b) Total RNA Preparation and Labelling

Tissues samples were homogenised in Trizol reagent (Invitrogen) followed by phase separation and subsequent purification of Total RNA using an RNeasy column (Qiagen) according to the manufacturers' protocols. mRNA was then amplified using standard techniques. Briefly, mRNA was reverse transcribed to cDNA using a T7 promoter tagged anchored PolyT primer. A second strand was synthesized in the presence of RNaseH and Klenow. The resulting double stranded molecules were used as template in an in vitro transcription reaction using a T7 Megascript kit (Ambion), according to the manufacturer's protocol, and purified using an RNeasy column. Amplified RNA was indirectly labeled by incorporation of amino-allyl dUTP (Sigma) during reverse transcription followed by coupling of cyanine-5 flurophor (Amersham). A common reference RNA containing eleven human tumour cell line RNAs was used in all hybridisations. Reference total RNA was isolated, amplified and labeled with cyanine-3 fluorphor (Amersham) in an identical manner to the tumour samples. Samples of labeled cDNA were cohybridised to spotted cDNA microarrays containing approximately 10,500 elements representing 9,389 unique cDNAs (UniGene build 144), washed and scanned (Scanarray 5000, Perkin Elmer) according to standard protocols. Data was extracted from scanned images using the Quantarray program (GSI Luminomics).

### Example 2

### Profiling a Tumour Sample

Samples of RNA from 121 well characterized tumour samples were analysed. To ensure the authenticity of the gene expression profiles and not to introduce errors into the class prediction algorithm, the diagnosis of these samples was verified by histopathology prior to inclusion in the study. RNA from tumour samples was isolated, amplified, and labelled, and the resulting labelled cDNA was hybridised to a spotted cDNA microarray containing 9,389 unique genes (UniGene build 144). After filtering to remove unusable spots, the data were normalized. Unsupervised hierarchical clustering using all genes in the filtered and normalized dataset showed the tumours grouped into their tissue of origin (FIG. 2), although not perfectly. This is a not an unexpected observation and is in agreement with other studies of a similar type. A list of genes that were significantly different in expression (p<0.05) between all the different tumour groups was then identified using the normalization technique and informatic tools such as k-nearest neighbours and SVM. Hierarchical clustering of the samples using these genes showed significant clustering of most members of the tumour groups (FIG. 3). Some tumour groups were distinct from every other tumour type (for example prostate), while others were initially more difficult to separate (lung, breast, ovarian). This most likely reflects the heterogeneity of the samples, and is overcome by increasing the representation of these tumour types.

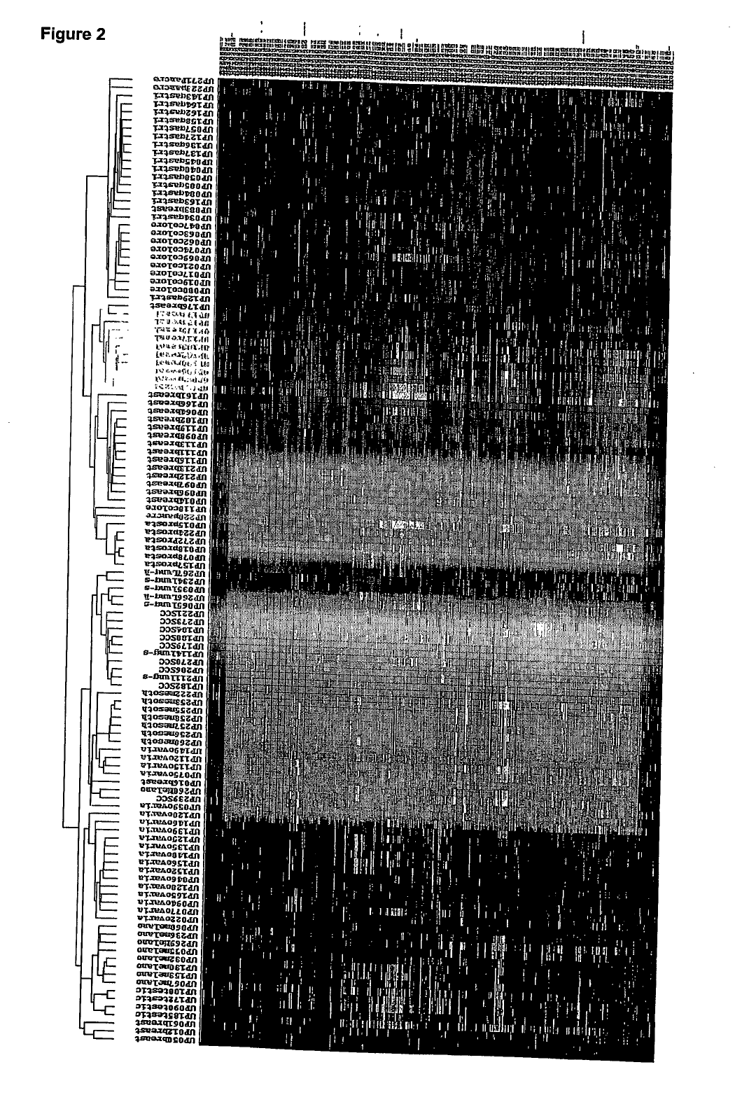

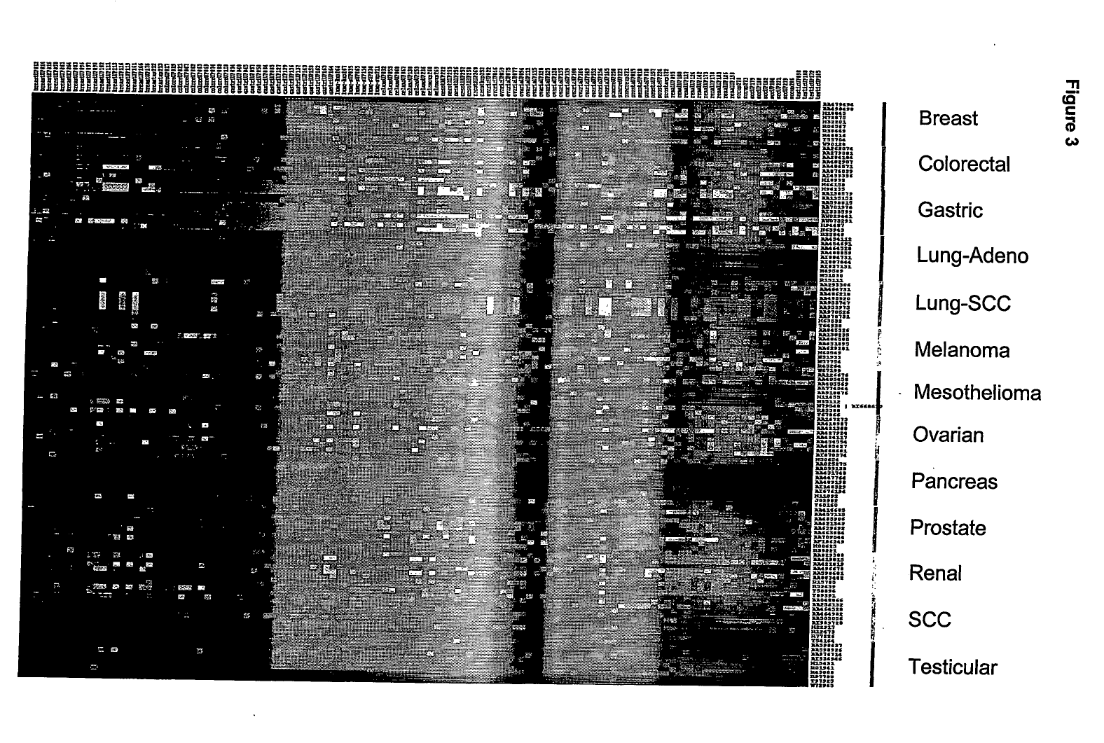

An algorithm for identifying the origin of carcinoma of unknown primary was implemented, which utilises a number of informatic tools including k-nearest neighbours and a support vector machine approach. The first stage is to reduce the number of genes from the approximately 9,389 unique genes on the microarray to an optimal subset, capable of reliably describing differences between tumour types. The optimal number and selection of genes for classification of tumours from a range of primary origins is determined by using an iterative signal to noise ratio algorithm. This method ranks genes according to the difference of their mean expression values for each class of tumour, divided by the sum of the standard deviations, ie. (m₁−m₂)/(s₁+s₂). This effectively identifies those genes that have a consistently different expression measurement within a given class of tumours, relative to the values of that gene across all other tumour types present. A subset of such genes is shown in FIG. 3. Genes are ranked according to this measurement and varying numbers of genes are tested to identify a subset with the highest predictive strength (FIG. 4).

A leave-one-out (LOO) cross validation in conjunction with the k-nearest neighbors algorithm to select and test subsets of genes was then used. Briefly, this algorithm seeks to classify an unknown sample by comparing it to samples of known class by using a distance metric. The class of the closest ‘k’ samples is assigned to the sample being tested. LOO involves permutations of the dataset whereby each sample is held out separately and a class assigned to it by using the remaining samples. This is repeated until each sample has been left out of the training set once and has been assigned to a class. The proportion of correct classifications is used a measure of predictor accuracy. From these predictions a confusion matrix can be constructed, as shown in FIG. 5. By plotting the actual tumour classes on one axis and the predicted classes on the other, a histogram-type view of the overall success or failure of the classification approach can be achieved. This representation also allows identification of any particular classes with more incorrect predictions relative to other tumour types. The average prediction accuracy in LOO analysis in our training set is approximately 97%.

Techniques such as clustering and class-prediction algorithms are sensitive to systematic differences between samples, for example the quality of RNA, or the preparation method. To verify that amplification did not introduce errors into the dataset, the fidelity of amplification by comparison of results derived from amplified and unamplified starting material was determined. The correlation between amplified and unamplified results was typically greater than 0.85. Between amplified samples, the correlation was greater, with a correlation coefficient of at least 0.97 (data not shown). We believe therefore that the class predictions made by this algorithm are unlikely to be influenced by amplification of mRNA derived from samples.

To test the validity of the prediction algorithm we used it to identify the origin of twelve samples of metastsic tumour from a known primary. All metastases were assigned to their correct class, ie known site of origin. p-values were significant in 10 cases (P<0.05) and bordering on significant (p=0.057, and p=0.058) in the remaining two (see FIG. 6). These specimens were not involved in any way in the construction of the prediction algorithm, and demonstrate that the prediction method is not specific (or ‘over fitted’) to samples contained in the training set of tumours and reflects classifications based on gene expression inherent to the tumour types.

### Example 3

### Diagnosis of Metastatic Tumour in the Ovary and Identification of Extra-Ovarian Origin

To demonstrate the wider utility of this approach to diagnosing metastatic tumour in the ovary, we analysed three samples of tumours from the ovary which were atypical presentations suggestive of an extra-ovarian origin for the tumour. Expression data from these samples strongly suggested a colorectal origin for these tumours (p<0.001 in all cases). Using only the unequivocally diagnosed ovarian and colorectal tumours in the training dataset, we identified a list of 55 genes which were significantly different between the ovarian and colorectal tumours. Importantly, several genes already known to be discriminators between these tumour types were included in the list. Using just these 55 genes, the five cases described above were clearly identified as colorectal in origin, and not unexpectedly, all ovarian and colorectal tumours were correctly segregated. We suggest that these genes are likely to be extremely useful as discriminators between colorectal and ovarian tumour in cases where the diagnosis is unclear or uncertain.

### Example 4

### Case Studies and Diagnosis of Primary Tumours

a) Colorectal Primary and Ovarian Secondary

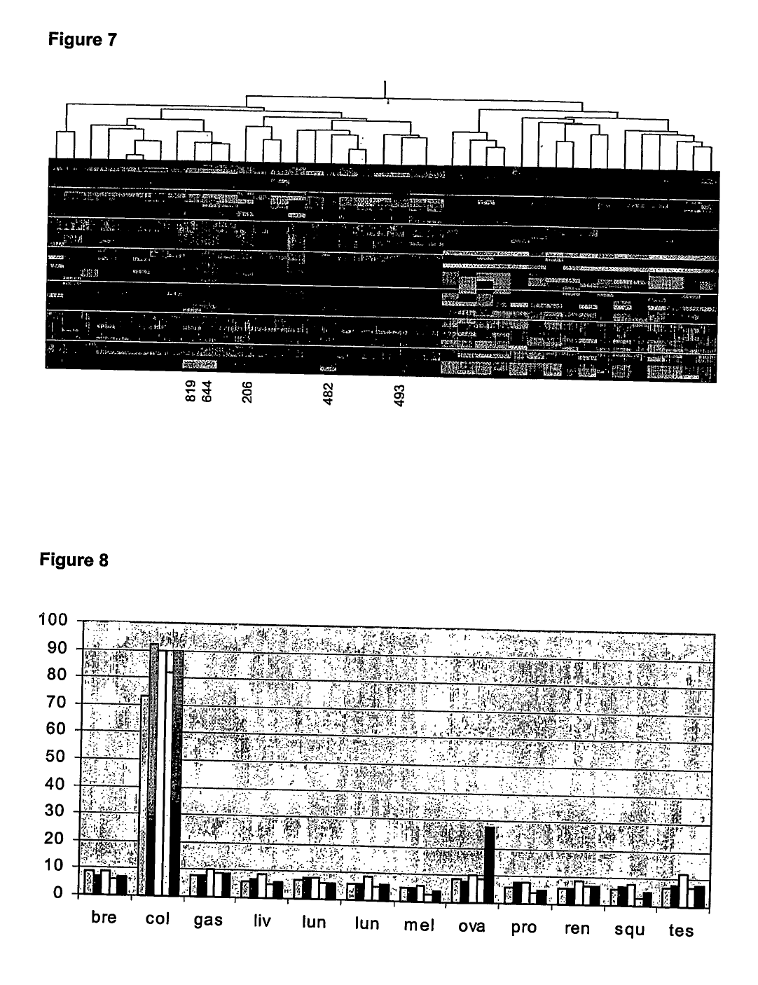

A patient (P00819, FIG. 7) presented with a large left ovarian mass. While the clinical picture was thought to be consistent with a possible primary ovarian cancer, this patient had presented with a Duke's C colon carcinoma one year previously. She underwent surgery and the histology was initially reported as a moderately differentiated mucinous adenocarcinoma with light microscopic appearances favouring a primary left ovarian cancer with omental involvement. Immunohistochemical analysis revealed a phenotype more consistent with a colonic metastasis, as the tumour was found to be CK 7 negative and CK 20 positive. This illustrates the scenario that we expect to frequently encounter where the clinical picture, diagnostic pathology and PET imaging suggest a primary tumour location, but without a high degree of certainty and with some conflicting data regarding the origin of the tumour. In this case, molecular profiling was of immediate applicability, and supported the immunophenotying of this tumour as colorectal.

b) Colorectal Primary and Pelvic and Peritoneal Secondary

The patient (P00644, FIG. 7) presented with a pelvic tumour mass and widespread peritoneal metastases. Surgical notes from the time of operation indicated it was unclear whether the patient had a primary ovarian or a primary colorectal cancer. Histology of the tumour was reported as a moderately differentiated endometroid adenocarcinoma with some focal mucinous differentiation, with the light microscopic appearances favouring ovary as the primary. Immunohistochemical staining with CK7 and CK20 monoclonal antibodies showed tumour cells variably co-expressing the two markers, which was thought to support an ovarian origin, although without a high degree of certainty. In this case, our molecular profiling suggested that the likely true origin of the tumour was colorectal.

c) Colorectal Primary and Ovarian Secondary

Further samples of tumours isolated from the ovary, where an extra-ovarian origin for the tumour was likely were examined. The first (P00482, FIG. 7) was a sample collected from the ovary of a woman with abdominal metastases at the time of left hemicolectomy, total abdominal hysterectomy and bilateral salpingo-oophrectomy. Molecular profiling identified a colorectal origin for the tumour, which was confirmed by histological analysis of sections of the colon, which showed that the patient had a Duke's stage D moderately differentiated adenocarcinoma of the sigmoid colon. The second patient (P00493, FIG. 7) presented with tumour present in both ovaries, and omentum. She had previously been treated for carcinoma of the sigmoid colon, and clinicians queried whether the tumour was a recurrence from the colorectal tumour, or an ovarian primary. In this case, microarray analysis indicated colorectal as the likely source of the tumour, which was confirmed by immunohistochemical staining which showed negative staining for cytokeratin 7, and positive staining for cytokeratin 20. The third patient (P00206, FIG. 7) was never diagnosed as a colorectal tumour metastatic to the ovary, although at the time of surgery, the pathologist noted, “although the (histologic) appearances would be consistent with mucinous ovarian carcinoma the appearances nevertheless raise the possibility of this representing spread from a colorectal primary tumour.”

### Example 5

### Various Uses of the Microassay

We expect that this test will be useful in a number of clinical situations. The first involves a patient presenting with no previous history of cancer, with extensive undifferentiated carcinoma. This is the classical presentation of carcinoma of unknown primary. In one such case (P00459), we analysed a sample of a carcinoma taken from a forty year-old non-smoker who presented with cough and dyspnoea. The patient was subsequently found to have multiple lung, supraclavicular, mediastinal and liver metastases. Histology review of the metastatic tumour described as an undifferentiated carcinoma. There was a larger lesion in the right lung on CT that may have been consistent with a primary. A PET scan did not reveal a definite primary, although a questionable abnormality in the lower oesophagus was noted. Subsequent gastroscopy was normal. Although the clinical picture was consistent with a diagnosis of a non-small cell lung cancer, there remained considerable uncertainty about the primary origin of this cancer in a young non-smoker. Expression profiling of this sample, and subsequent comparison with the training dataset determined that this sample had an expression profile most consistent with the tumour being lung in origin, with a significant p-value of 0.027. This case illustrates the scenario where the clinical picture, diagnostic pathology and imaging suggested a primary tumour location, but with some remaining doubt. Array analysis subsequently confirmed the clinical observations.

The second scenario we expect to encounter frequently is the unusual presentation of a common tumour, when that patient has a clinical history of a previous cancer. One of the patients in our study (P00563), a thirty-one year old woman with a past history of a stage I high-grade mucinous borderline ovarian tumour six years previously, presented with a twelve month history of left pelvic pain and was found to have a sclerotic abnormality involving the left ilium and left upper femur. Bone scan revealed multiple bone metastases. Biopsy from the left ilium revealed adenocarcinoma. The patient underwent CT scan of the chest/abdomen/pelvis, a PET scan, a thallium scan and a mammogram without any evidence of a primary being found. Pathology review suggested that the histology was consistent with a previous ovarian malignancy, but could not exclude a carcinoma arising in the breast, lung or gastrointestinal tract. The presentation with bone metastases was thought to be most unusual for recurrent ovarian cancer and the treating clinician thought that it was more likely that the cancer had arisen from another site. The patient was treated as an unknown primary with a combination of epirubicin, cisplatin and 5-fluorouracil. Our array analysis confirmed the possible diagnosis of a relapse from the ovarian primary, and it is possible that information such as this may have altered the management of this patient.

The third scenario involves a patient with a clear history of malignancy, but with metastatic tumour where it is unclear whether the metastatic tumour has arisen from the first, or a new, primary tumour. In some cases, we expect that array analysis would be able to confirm the identification of a relapsed primary tumour, and in others to suggest a new primary site. Both of these scenarios were encountered during this work. The first was a patient (P00563) diagnosed in February 1994 with Stage IIC endometrioid carcinoma of the ovary. CA125 was elevated at 327 pre-operatively and was still elevated post-operatively at 80. She underwent a total abdominal hysterectomy with bilateral salpingo-oophorectomy and omentectomy. She was then treated with six cycles of carboplatin and cyclophosphamide. She remained well until May 1998 when she developed back pain and was found to have sclerotic bone metastases (investigations included plain x-ray, CT and bone scan). Mammogram at this time was normal. The CT scan did not reveal any other evidence of metastatic disease. T9 metastasis was biopsied and revealed a poorly differentiated adenocarcinoma, which was oestrogen and progesterone receptor negative. There was no clinical evidence of another primary. Although the development of sclerotic bone metastases was thought to be an unusual pattern of relapse for ovarian cancer, the decision was made to treat her as ovarian cancer. In addition to the CT she also had a PET scan, which was unhelpful. Following palliative radiotherapy to thoracic spine, she went on to receive six cycles of carboplatin and taxol. The response was difficult to assess though there was some slight improvement on bone scan. The CA125 tumour marker was not elevated and never rose subsequently. By October 1999 there was a definite mass in the left neck and initial attempt to biopsy this mass in January 2000 did not reveal any malignant cells. In April 2000, due to progressive growth and symptoms from the neck mass the patient received palliative radiotherapy, and commencing in June 2000 received four cycles of carboplatin with the best response of stable disease. In November 2000, there was an impression of a mass in the outer left quadrant of the left breast with some suspicious changes of malignancy on mammogram in the same area. However, biopsy of the breast mass was negative. The patient also had a repeat biopsy of the neck mass, which revealed an undifferentiated carcinoma. At this time she was also thrombocytopaenic and had developed liver metastases. Bone marrow examination revealed a similar undifferentiated carcinoma. She was commenced on capecitabine but tolerated this poorly and this treatment was ceased. She subsequently went on to receive weekly taxotere with improvement in her thrombocytopaenia but progressive liver metastases. She was subsequently treated palliatively, and died in May 2001. At the time she was initially found to have bone metastases she was regarded as an atypical relapse of ovarian cancer but there was always concern that she may have had another primary, in particular, a breast primary in view of the sclerotic bone metastases. By November 2000, there was a strong clinical suspicion that she may have had breast cancer, and this influenced the decision to use capecitabine and docetaxel chemotherapy. Although the biopsy of the breast mass was negative this was a poor sample and may have been a false negative. The clinical and mammographic appearances of the breast lesion were consistent with a breast primary, as was the pattern of metastases with liver, bone marrow, left supraclavicular and sclerotic bone metastases. Analysis of this sample by microarray, subsequent to the patient's death confirmed the suspicion that the metastatic cancer was not a relapse of the patient's initial ovarian cancer, but a new breast primary.

The alternative scenario, where a relapse was suggested, involved a seventy year old man (P01242) who was diagnosed with prostate cancer ten years previously and treated by transurethral resection of the prostate, radiotherapy and had remained on Zoladex and flutamide. He presented with a painful lesion on his left ear and a lump in the left upper neck. Biopsy of the ear lesion revealed no evidence of malignancy, but initial core biopsy of the hard 1.5 cm left upper neck mass was reported as poorly differentiated metastatic carcinoma, and immunohistochemistry for PSA was negative. Serum PSA was also normal. He was referred to another hospital for further investigation. A repeat biopsy was performed and our analysis of a sample by molecular profiling identified prostate as the likely source of the tumour. This biopsy was initially reported as metastatic adenocarcinoma with focal neuroendocrine differentiaition, and the pathologist recommended that a lung primary should be excluded. Repeat immunohistochemical staining for PSA on this biopsy was requested after the array result was already known, and this was positive consistent with metastatic prostate cancer.

The data presented shows that the use of expression profiling is able to contribute to the management of cancer patients. This work demonstrates that whilst expression changes may occur in some genes as a result of tumour development, or admixing of cells with other cell types such as stroma or vascular elements, the mass effect of measuring the expression patterns of thousands of genes means that distinctive patterns of tumour types are identifiable. Further, expression profiles are shown to be sufficient to classify tumour samples according to tissue of origin. It has been demonstrated that, not only can tumours be partitioned with respect to tissue of origin using microarray analysis, but additionally the expression patterns can be used to positively identify samples which were previously unknown.

### Example 6

### Use of RT-PCR

a) Extraction of RNA from Paraffin Embedded Formalin Fixed Tissue (FFPET)

Extraction of RNA was performed using a modification to the protocol described by Specht et al (2001, Am J Pathol 158(2): 419-29). Briefly, paraffin was removed from microtome sectioned material by incubating in Xylene, repeating the procedure twice and then sequentially washing with 100%, 90% and 70% ethanol. Samples were then dried before the addition of Proteinase K digestion buffer (10 mM Tris HCl (pH 8.0), 0.1 mM EDTA (pH8.0), 2% SDS), and 100 mg of Proteinase K, followed by incubation at 60° C. for 16 hours or overnight. Following the initial incubation period an additional 100 mg of proteinase K was added and samples were digested for a further 3-4 hours at 60° C. RNA was purified from the tissue lysate by column chromatography (Rneasy, Qiagen) using a modification to the manufacturers protocol. This involved sequentially adding 440 μL of 100% ethanol and 660 μL of buffer RLT buffer to the tissue lysate. The sample was then briefly mixed before passing it through the column by centrifugation (RNeasy mini). Subsequent washes were applied as per described by the manufacturer followed by elution in an appropriate volume of RNAse free deionised water.

b) Quantitative Real Time PCR

Total RNA was reverse transcribed by priming with random hexamers. Success of the reverse transcription and relative quantification of the cDNA was interpreted using 5 endogenous control genes, analysed by real time PCR using SYBR green chemistry (ABI Prism 7000). The endogenous control genes CTCF, CAPZB, TXNL, SF3B1, RABGGTB and PGK were chosen from microarray experiments based on the criteria of low variability across multiple cancer classes and a minimum expression level in excess of three times that of background. All primer pairs were designed across exon boundaries to prevent amplification of genomic DNA. An average of the Ct values for the endogenous controls was used to assess the quantity of cDNA present. A maximum average Ct threshold was set to exclude samples not suitable for further analysis on micro fluidics card.

c) Micro Fluidics Card

A set of 89 genes was chosen by signal to noise gene selection using a 6 class training set of breast, colorectal, ovarian, gastric, pancreas and a combined class (others) representing other sites of origin (ie lung, melanoma, prostate, renal, mesothelioma, testicular, SCC). The genes represent the top ranked 12 to 17 markers for each respective class by signal to noise gene selection. All genes were chosen from Applied Biosystems Assay on Demand (AoD) pre-validated primer probe sets. If a gene marker selected by the signal to noise metric was not available from the AoD set then the next highest ranking gene was selected. Additionally, seven endogenous controls were added to the assay set including the 5 genes previously described for cDNA quality control and mandatory controls 18s rRNA and GAPDH. Custom microfluidics cards were designed in a configuration allowing the processing of 4 samples and 96 assays on a single card.

A master mix of reagent was prepared from TaqMan® Universal PCR Master Mix and sample cDNA template. The volumetric amount of template used was proportional to that used for quality control with no attempt to standardise the absolute amount of template added between samples. Reactions were run according to the manufacturers protocol with data collection based on absolute Ct values. Normalisation of RT-PCR assays was conducted using an average Ct value for all endogenous controls excluding GAPDH. Samples were then converted to a fold ratio relative to endogenous controls described using standard delta Ct formula.
i.e X=2^{ΔCt} where ΔCt=(Ct_{target}−Ct_{average endogenous controls})

### Example 7

### Generation of Gene Expression Database—Validation of RT-PCR Results

A cohort of 42 samples spanning five anatomical sites of origin (breast, colorectal, gastric, pancreas, ovarian) was profiled using RT-PCR by custom micro fluidics cards. All reactions were performed using cDNA generated from RNA extracted from fresh frozen tissue. These samples had been previously analysed using cDNA microarrays. A comparison of median normalised data by heat map alignment shows the consistency between the two platforms (FIG. 9).

The chemistry used for RT-PCR analysis allows the utilisation of nucleic acids that may be partially degraded or fragmented, as opposed to microarray analysis where high quality intact mRNA is required. Formalin fixation of tissue is routinely used in conventional pathology to conserve tissue architecture and preserve protein complexes that may be targeted by immunohistochemical detection as cancer specific markers. The cross-linking events that allow this preservation, however, are detrimental to RNA and DNA integrity. Nucleic acids extracted from such material are therefore composed of short fragments, typically of around 300 bp in length. RT-PCR requires the amplification of only short lengths of DNA. Amplicon lengths generated from AoD primer sets are approximately 60 bp in length.

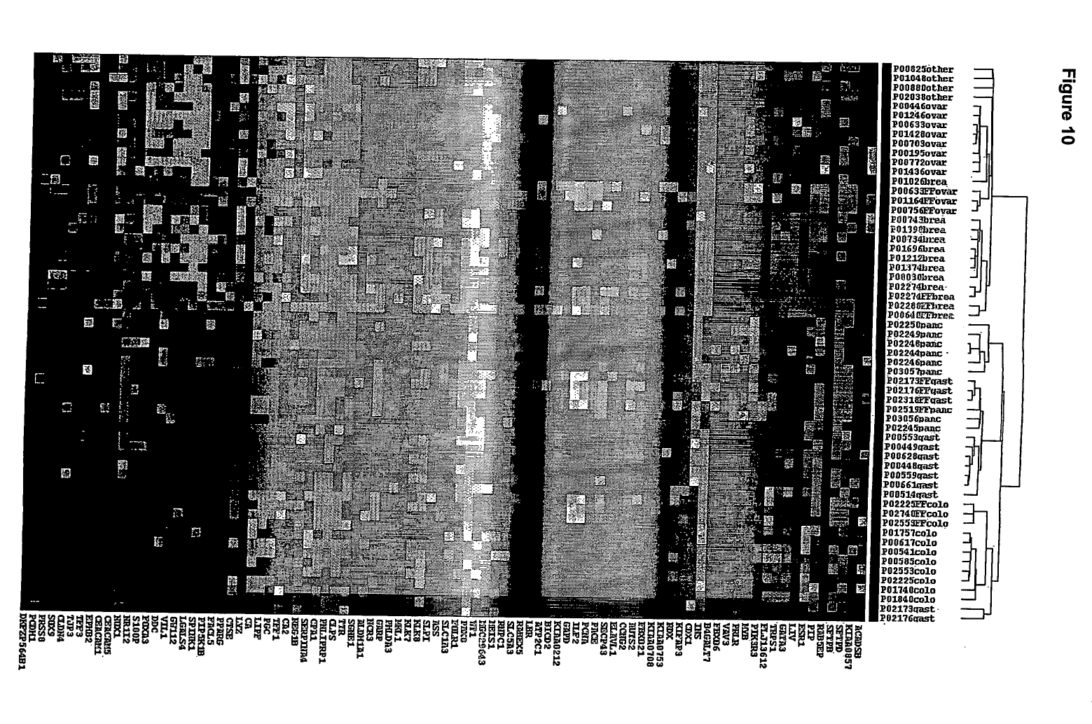

Applicants have used RNA extracts from FFPET for expression profiling using RT-PCR using the micro fluidics format. A total of 13 samples from 5 sites of origin were processed providing high quality data. Clustering of samples processed from both fresh frozen tissue and FFPET show that samples can accurately be grouped into respective tumour classes regardless of the tissue processing method used prior to RNA extraction (FIG. 10).

Similar to microarray data, data generated from RT-PCR can be used for machine learning and creating class predictor models. All RT-PCR data was used for generating an SVM predictor model of 5 classes (breast, gastric, ovarian, colorectal and pancreas) using the method of ranking. Using 5 RankLevels applicants achieved a LOO cross validation accuracy of 100%. The versatility of a rank method for cross platform meta-analysis was also applied to both microarray and RT-PCR datasets. Training solely using data generated by cDNA microarray SVM models were generated that can be tested upon similar samples profiled using RT-PCR. Using this cross platform meta-analysis a high prediction accuracy of 93% was obtained in the independent test.

### Example 8

### Testing Strengths of Predictions

The strength of the prediction capability for a carcinoma unknown primary (CUP) was tested. This test is indicative of whether a prediction of the tissue of origin for a carcinoma of unknown primary is correct. When a class or histological subclass is left out of a training set used to establish the gene database the prediction accuracy of the test is compromised. This demonstrates the importance of having all classes or subclasses present when establishing a training set.

The present example tests the veracity of the prediction strength algorithm, and associates a confidence with the prediction.

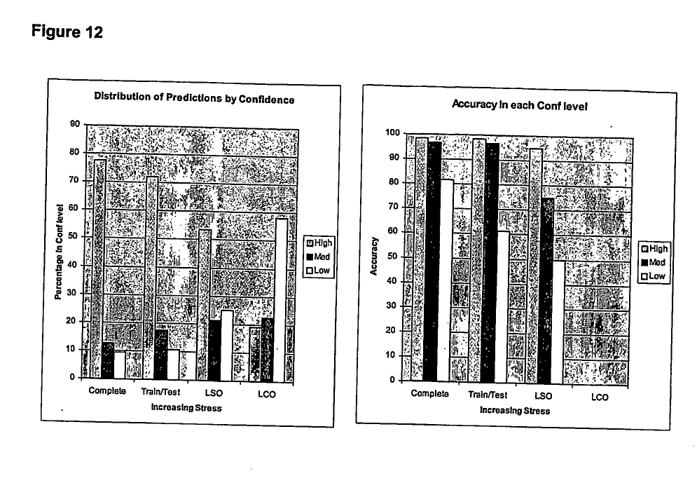

FIG. 12 shows that data set size has an impact on the confidence of the prediction. By changing the number of samples in the dataset available for comparison, the degree of confidence is affected. Lowering the number or leaving out data sets reduces the confidence level.

Finally it is to be understood that various other modifications and/or alterations may be made without departing from the spirit of the present invention as outlined herein.

1. A method of profiling a biological sample, said method including:
obtaining a gene expression profile from the biological sample;
obtaining a gene expression database from one or more biological samples;
identifying different patterns of gene expression between the biological samples;
identifying genes that comprise the different patterns of gene expression; and
correlating the genes that comprise the different patterns of gene expression of the gene expression profile of the biological sample and the gene expression database to provide a profile of the biological sample.

2. A method according to claim 1 wherein the patterns of gene expression are normalized by using an iterative signal to noise ratio algorithm wherein:
(m₁−m₂)/(s₁+s₂)
and where
m=mean expression value; and
s=standard deviation.

3. A method according to claim 1 wherein the gene expression is processed by a formula for normalization according to the formula:
X=2^{ΔCt} where ΔCt=(Ct_{target}−Ct_{average endogenous controls})

4. A method according to claim 1 wherein the different patterns of gene expression are identified by an analysis which employs an algorithm utilising a k-nearest neighbours and/or support vector machine (SMV) approach.

5. A method according to claim 1 wherein the patterns of gene expression are further clarified using leave-one-out (LOO) cross validation in conjunction with a k-nearest neighbour algorithm and/or SVM.

6. A method according to claim 1 wherein the gene expression profiles and the gene expression databases include gene expression data that is processed by ranking genes according to their expression levels within a sample and allocating a rank to the gene such that the rank of the gene identifies different patterns of gene expression between the biological samples.

7. A method according to claim 6 wherein the rank is allocated a rank level using the following formula:
RankLevel=ceil(number of rank levels×rank of the gene/number of genes assayed)=ceil(x) wherein ceil(x)=smallest integer≧x

8. A method according to claim 1 wherein the gene expression profile includes gene expression data obtained by analysis of gene expression from the biological sample by at least one method selected from the group including RNA expression analysis, DNA expression analysis and transcription rate analysis.

9. A method according to claim 1 wherein the analysis of gene expression is obtained by RNA expression analysis.

10. A method according to claim 1 wherein the analysis of gene expression is obtained by a hybridisation based method or a PCR based method.

11. A method according to claim 1 wherein the analysis of gene expression is obtained by microarray analysis.

12. A method according to claim 1 wherein the analysis of gene expression is obtained by quantitative RT-PCR.

13. A method according to claim 1 wherein the analysis of gene expression is obtained by microarray and quantitative RT-PCR.

14. A method according to claim 1 wherein the biological sample is selected from the group including normal tissue, a pre-cancerous, cancerous or tumour tissue, a primary tumour sample, cells from pleural effusions, or metastatic samples.

15. A method according to claim 1 wherein the tumour tissue is from a tumour of unknown origin.

16. A method according to claim 1 wherein the gene expression database is generated from a plurality of gene expression profiles of biological samples and/or samples of tumour types.

17. A method according to claim 16 wherein the tumour types are selected from the group including gastric, colorectal, pancreatic, breast and ovarian.

18. A method according to claim 17 wherein the tumour samples or tumour types are selected from Table 1.

19. A method according to claim 1 wherein the gene expression profile or the gene expression database includes an analysis of a gene selected from Table 2.

20. A method of processing gene expression data obtained from more than one gene expression analysis of a biological sample, said method including ranking genes according to their expression ratios within a sample processed by the gene expression analysis and allocating a rank to the gene such that the rank of the gene identifies a different pattern of gene expression between the biological samples.

21. A method according to claim 20 wherein the rank is allocated a rank level using the following formula:
RankLevel=ceil(number of rank levels×rank of the gene/number of genes assayed)=ceil(x) wherein ceil(x)=smallest integer≧x

22. A method according to claim 20 wherein the gene expression data is normalised using an iterative signal to noise ratio algorithm wherein:
(m₁−m₂)/(s₁+s₂)
and where
m=mean expression value; and
s=standard deviation.

23. A method according to claim 20 wherein the gene expression data is processed by a formula for normalization according to the formula:
X=2^{ΔCt} wherein ΔCt=(Ct_{target}−Ct_{average endogenous controls})

24. A method according to claim 20 wherein the gene expression data has been analysed using an algorithm utilising a k-nearest neighbours and/or a support vector machine (SMV) approach.

25. A method according to claim 20 wherein the gene expression data is further clarified using leave-one-out (LOO) cross validation in conjunction with a k-nearest neighbour algorithm and/or SVM.

26. A method according to claim 20 wherein the gene expression data is obtained by analysis of gene expression from the sample by at least one method selected from the group including RNA expression analysis, DNA expression analysis and transcription rate analysis.

27. A method according to claim 20 wherein the analysis of gene expression is obtained by RNA expression analysis.

28. A method according to claim 20 wherein the analysis of gene expression is obtained by a hybridisation based method and/or a PCR based method.

29. A method according to claim 20 wherein the analysis of gene expression is obtained by microarray analysis.

30. A method according to claim 20 wherein the analysis of gene expression is obtained by quantitative PCR.

31. A method according to claim 20 wherein the analysis of gene expression is obtained by microanalysis and quantitative PCR.

32. A method according to claim 20 wherein the biological sample is selected from the group including normal tissue, a pre-cancerous, cancerous or tumour tissue, primary tumour and metastatic tumour, or cells from a pleural effusion.

33. A method according to claim 32 wherein the tumour tissue is from a tumour of unknown origin.

34. A method according to claim 33 wherein the tumour tissue is derived from a tumour type selected from the group including gastric, colorectal, pancreatic, breast and ovarian.

35. A method according to claim 34 wherein the tumour tissue is selected from samples of Table 1.

36. A method according to claim 20 wherein the genes are selected from Table 2.

37. A gene expression database including gene expression profiles from biological samples, said gene expression profiles including gene expression data obtained by analysis of different patterns of gene expression from the biological sample, said data obtained by at least one method selected from the group including RNA expression analysis, DNA expression analysis and transcription rate analysis.

38. A gene expression database according to claim 37 wherein the analysis of the gene expression is normalised by using an iterative signal to noise ratio algorithm wherein:
(m₁−m₂)/(s₁+s₂)
and where
m=mean expression value; and
s=standard deviation.

39. A method according to claim 37 wherein the gene expression is processed by a formula for normalization according to the formula:
X=2^{ΔCt} where ΔCt=(Ct_{target}−Ct_{average endogenous controls})

40. A gene expression database according to claim 37 wherein different patterns of gene expression are identified by analysis which employs an algorithm utilising a k-nearest neighbours and support vector machine (SMV) approach.

41. A gene expression database according to claim 37 wherein the different patterns of gene expression are further clarified using leave-one-out (LOO) cross validation in conjunction with a k-nearest neighbour algorithm.

42. A gene expression database according to claim 37 wherein the gene expression data of the sample obtained by analysis of different patterns of gene expression is processed by ranking genes according to an expression ratio of the gene within the sample, and allocating a rank to the gene such that the rank of the gene identifies a different pattern of gene expression between the biological samples.

43. A gene expression database according to claim 42 wherein the rank is allocated using a formula:
RankLevel=ceil(number of rank levels×rank of gene/number of genes assayed)=ceil(x), wherein ceil(x)=smallest integer≧x

44. A gene expression database according to claim 37 wherein the analysis of gene expression is obtained by RNA expression analysis.

45. A gene expression database according to claim 37 wherein the analysis of gene expression is obtained by a hybridisation based method or a PCR based method.

46. A gene expression database according to claim 37 wherein the analysis of gene expression is obtained by microarray analysis.

47. A gene expression database according to claim 37 wherein the analysis of gene expression is obtained by quantitative PCR.

48. A gene expression database according to claim 37 wherein the analysis of gene expression is obtained by microarray and quantitative PCR.

49. A gene expression database according to claim 37 wherein the biological sample is selected from the group including normal tissue, a pre-cancerous, cancerous or tumour tissue, primary tumour or malignant tumour or cells from a pleural effusion.

50. A gene expression database according to claim 37 wherein the tumour tissue is from a tumour of unknown origin.

51. A gene expression database according to claim 37 wherein the gene expression database is generated from a plurality of gene expression profiles.

52. A gene expression database according to claim 37 wherein the tumour tissue is derived from a tumour type selected from the group including gastric, colorectal, pancreatic, breast and ovarian.

53. A gene expression database according to claim 37 wherein the tumour tissue is selected from samples of Table 1.

54. A gene expression database according to claim 37 database which includes an analysis of a gene selected from Table 2.

55. A method of evaluating an origin of a tumour sample, said method including:
obtaining a gene expression profile of the tumour sample;
comparing the gene expression profile of the tumour sample to a gene expression database said database including gene expression profiles from known tumour samples, said gene expression profiles including gene expression data obtained by analysis of gene expression from the known tumour samples by at least one method selected from the group including RNA expression analysis, DNA expression analysis and transcription rate analysis; and
identifying the origin of the tumour sample when a gene expression profile from the gene expression database correlates with the gene expression profile of the tumour sample.

56. A method of evaluating an origin of a tumour sample, said method including:
obtaining a gene expression profile of the tumour sample according to claim 1;
comparing the profile of the tumour sample to a gene expression database, said gene expression database including gene expression profiles from biological samples, said gene expression profiles including gene expression data obtained by analysis of different patterns of gene expression from the biological sample, said data obtained by at least one method selected from the group including RNA expression analysis, DNA expression analysis and transcription rate analysis; and
identifying an origin of the tumour sample when a gene expression profile from the gene expression database correlates with the gene expression profile of the tumour sample.

57. A method according to claim 55 wherein the origin of the tumour sample is identified when a pattern for gene expression from the gene expression database correlates to a pattern from the gene expression profile of the tumour sample.

58. A method according to claim 55 wherein the origin of the tumour sample is identified when a rank level for gene expression from the gene expression database correlates to a rank level from the gene expression profile of the tumour sample.

59. A method according to claim 58 wherein more than one rank level for gene expression from the gene expression database correlates to more than one rank level from the gene expression profile of the tumour sample.

60. A method according to claim 55 wherein the tumour sample is selected from the group including a pre-cancerous, cancerous or tumour tissue, primary tumour and malignant tumour.

61. A method according to claim 55 wherein the tumour sample is from a tumour of unknown origin.

62. A method of treating a patient having a tumour of unknown origin, said method including:
identifying the tissue of origin of the tumour of unknown origin; and
treating the patient in a manner appropriate for treating a tumour originating from that tissue.

63. A method of treating a patient having a tumour of unknown origin, said method including:
identifying the origin of the tumour of unknown origin according to claim 55; and
treating the patient in a manner appropriate for treating a tumour originating from that tissue.

64. A microarray having a plurality of loci and having an oligopeptide affixed to the loci, said oligopeptide capable of binding to a gene selected from Table 2.

65. A microarray when used for profiling a tumour according to claim 1.

66. A microarray when used for obtaining a gene expression database according to claim 37.
